(19) United States
(12) Patent Application Publication
(10) Pub. No.: US 2026/0202503 A1
(43) Pub. Date: Jul. 16, 2026

(54) METHODS, ARCHITECTURES, APPARATUSES AND SYSTEMS FOR ADAPTIVE MEASUREMENT TIME WINDOWS FOR SENSING

(71) Applicant: InterDigital Patent Holdings, Inc., Wilmington, DE (US)

(72) Inventors: Mohammad Heggo, Lewisham (GB); Arman Shojaeifard, London (GB); Yasser Mestrah, London (GB); Ibrahim Hemadeh, Hemel Hempstead (GB); Alain Mourad, Ascot (GB); Fumihiro Hasegawa, Westmount (CA)

(21) Appl. No.: 19/017,162

(22) Filed: Jan. 10, 2025

(51) Int. Cl. G01S 7/00; G01S 13/86; H04B 17/336; H04L 5/00; H04W 24/08

(52) U.S. Cl. CPC G01S 7/006; G01S 13/86; H04B 17/336; H04L 5/0048; H04W 24/08

(57) ABSTRACT

Procedures, methods, architectures, apparatuses, systems, devices, and computer program products are provided for adaptive measurement time windows for sensing. Wireless transmit/receive unit (WTRU) methods and systems include performing first sensing measurements of a sensing target during a first measurement time window. The methods and systems further include determining a length mismatch corresponding to dwelling time information associated with the sensing target and based on the first sensing measurements, determining a second measurement time window based on the length mismatch, and performing second sensing measurements of the sensing target during the second measurement time window.

### TECHNICAL FIELD

The present disclosure is generally directed to the fields of communications, software and encoding, including, for example, to methods, architectures, apparatuses, systems related to integrated sensing and communication (ISAC) (e.g., detecting a target object based on configuration of at least one of a wireless transmit/receive unit or a wireless network).

### BACKGROUND

A device (e.g., a wireless transmit/receive unit) that is communicatively coupled to a wireless network may perform sensing measurements of a sensing target associated with a sensing task during a configured measurement time window. The length of the configured measurement time window may be shorter or longer than a period of a motion (e.g., rotation and/or vibration) of the sensing target. Consequently, the performed sensing measurements may have high uncertainty and low accuracy, or incur greater signal overhead than needed to perform the sensing task.

### SUMMARY

A wireless transmit/receive unit (WTRU) may be configured for ISAC. For example, a WTRU may perform sensing tasks based on receiving reference signals (RSs) reflected off a sensing target. In some embodiments, a WTRU receives sensing configuration information (e.g., from a wireless network entity) and performs first sensing measurements during a first measurement time window based on the received sensing configuration. However, a sensing task (e.g., micro doppler (MD) signature measurement for sensing target sub-motion) may have unique dwelling time requirements. In accordance with certain embodiments of this disclosure, the WTRU determines dwelling time information associated with the sensing target based on the first sensing measurements in order to, for example, better align the measurement time window with the dwelling time for future measurements. For example, the WTRU may determine a length mismatch based on the dwelling time information, determine a second measurement time window (e.g., composed of bundled and/or segmented measurement time windows) based on the length mismatch, and perform second sensing measurements of the sensing target during the second measurement time window. Based on the systems and methods of this disclosure, sensing measurement tasks (e.g., for detecting sensing target sub-motion) may be performed by the WTRU with greater accuracy, lower uncertainty, and/or lower signaling overhead.

In accordance with certain embodiments of the present disclosure, methods and systems are provided for operating a WTRU. The methods include receiving sensing configuration information associated with a sensing target. The methods further include performing first sensing measurements of the sensing target during a first measurement time window based on the sensing configuration information. The methods additionally include determining dwelling time information associated with the sensing target based on the first sensing measurements. The methods also include determining a length mismatch based on the dwelling time information and determining a second measurement time window based on the length mismatch. The methods further include performing second sensing measurements of the sensing target during the second measurement time window. In some embodiments, the methods further include reporting, to a wireless network entity, an indication of the length mismatch, an indication of the second measurement time window, and the second sensing measurements.

In some embodiments, the determining the length mismatch includes comparing the dwelling time information to a threshold. In some embodiments, the comparing indicates that the length mismatch is short and performing the second sensing measurements includes bundling sensing measurements from a plurality of measurement time windows. In some embodiments, the comparing indicates that the length mismatch is long and performing the second sensing measurements includes selecting one or more segments of a subsequent measurement time window and performing the second sensing measurements during the one or more segments.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is an illustrative diagram of micro-doppler (MD) measurements in an integrated sensing and communication (ISAC) approach, in accordance with certain embodiments;

FIGS. 3A-B are illustrative charts of reference signal (RS) power delay profiles, in accordance with certain embodiments;

FIG. 4 is an illustrative chart of accumulated RS resource measurements, in accordance with certain embodiments;

FIGS. 5A-B are illustrative charts of RS power frequency responses at different dwelling times, in accordance with certain embodiments;

FIG. 6 is an illustrative diagram of performing measurements of multiple transmitted RSs within a measurement time window, in accordance with some embodiments;

FIGS. 7A-C are illustrative charts of a target MD profile corresponding to non-periodic target MD motion, in accordance with some embodiments;

FIG. 8 is an illustrative chart comparing signal-to-noise ratio (SNR) of a received RS with different measurement time window lengths, in accordance with some embodiments; and

FIG. 9 is a flowchart of an illustrative method performed by a wireless transmit/receive unit (WTRU) for adaptive measurement time windows for sensing, in accordance with certain embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

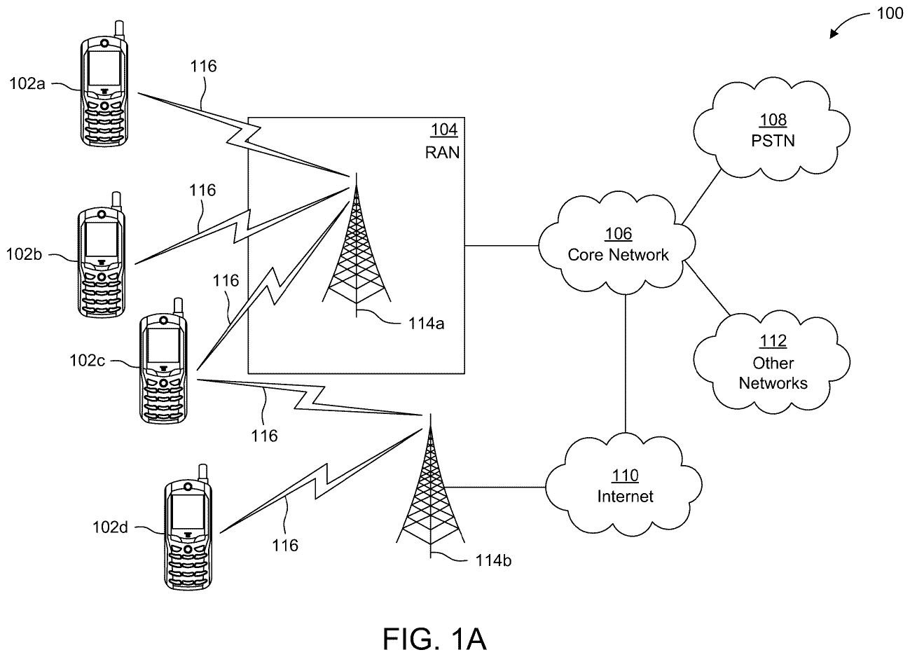

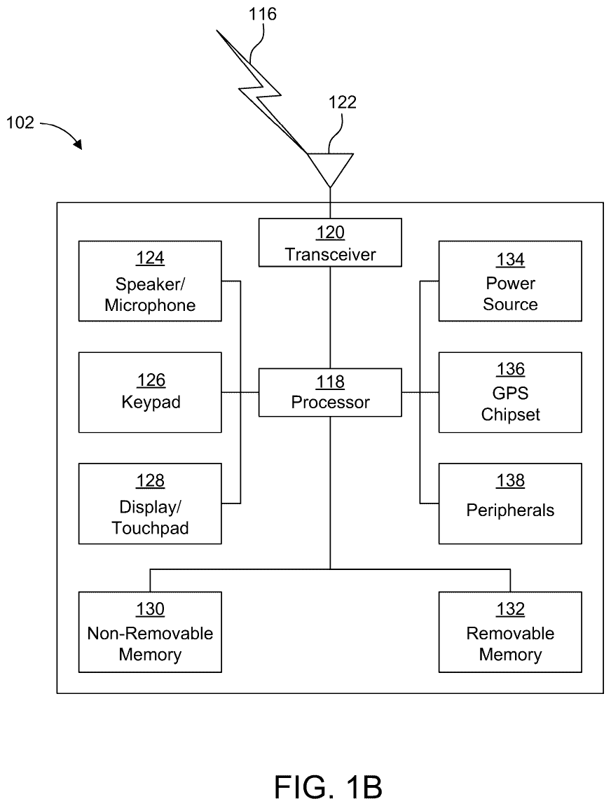

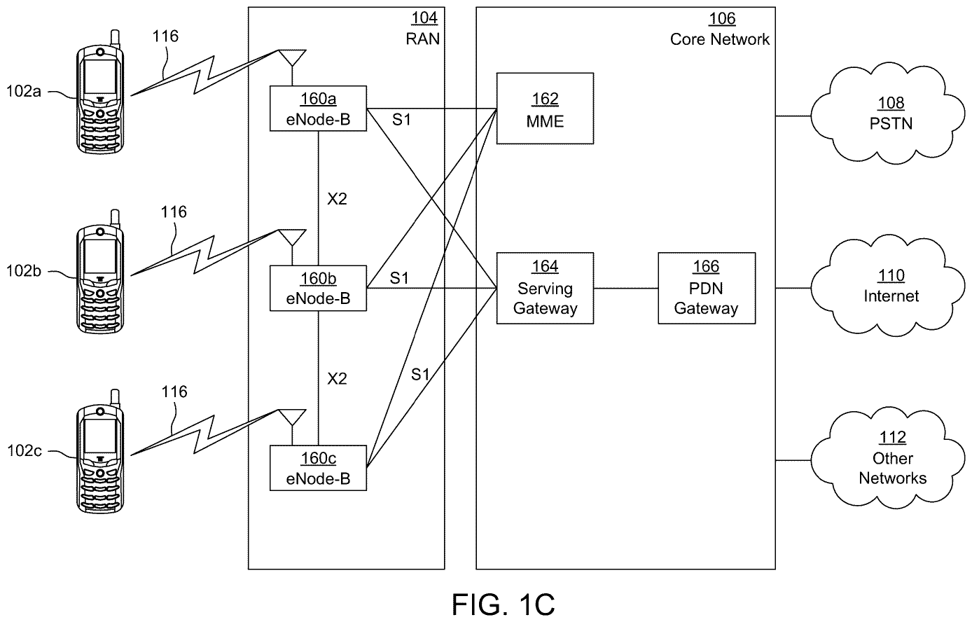

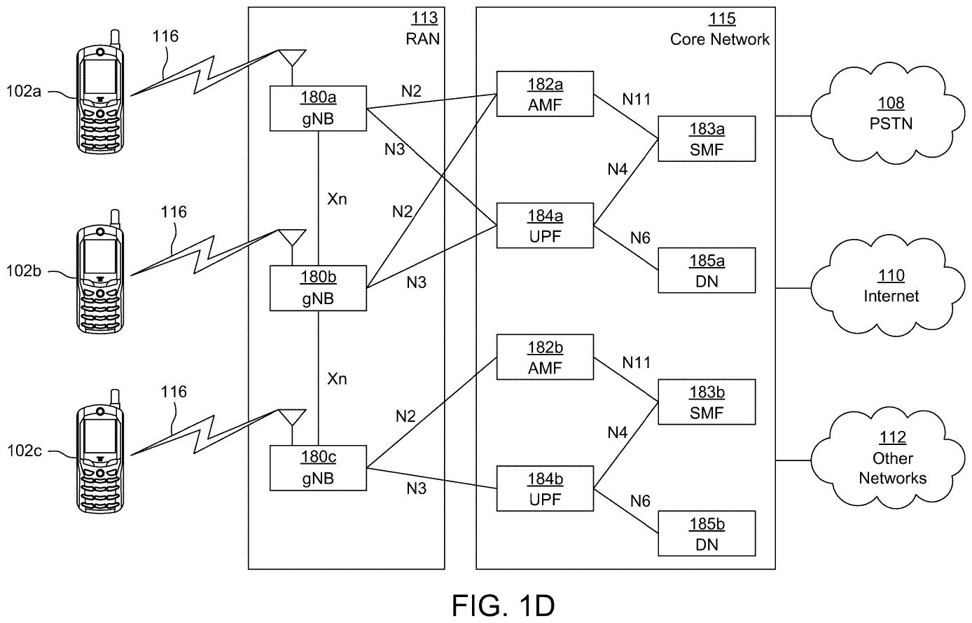

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, orthogonal frequency division multiplexing (OFDM) symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

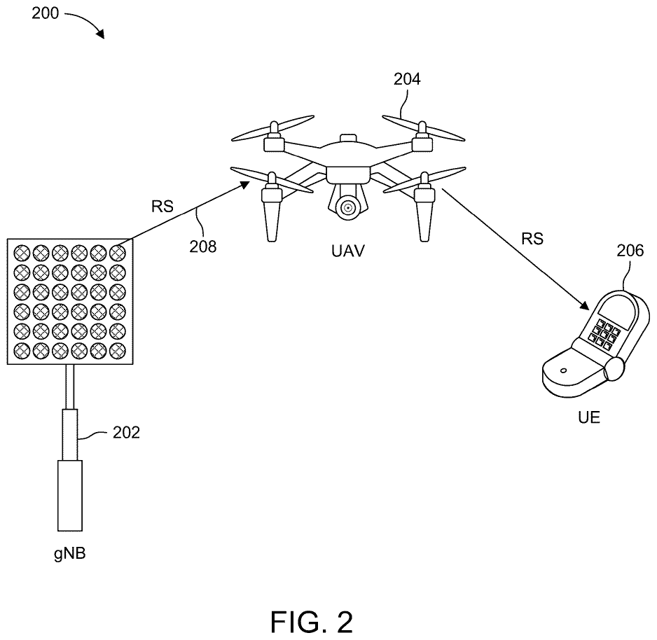

In certain embodiments of the present disclosure, including those described below at least in connection with FIG. 2, the devices, systems, architectures, communication links, apparatuses, and other elements depicted in FIGS. 1A-1D may be used in connection with adaptive measurement time windows for sensing.

FIG. 2 is an illustrative diagram 200 of micro-doppler (MD) measurements in an ISAC scenario, in accordance with certain embodiments.

In some approaches, sub-motions (e.g., other than a main bulk motion) of a target or a structure on the target may result in MD frequency shifts. For example, such sub-motions may include rotation, vibration, combinations of the same, or the like. Further, for example, targets may include humans, animals, vehicles, unmanned aerial vehicles (UAV), combinations of the same, or the like.

For example, an ISAC approach may include a WTRU 206 performing sensing measurements for a UAV sensing target 204 in connection with a gNB 202 of a wireless network. As shown in FIG. 2, an MD signature of the sensing target 204 (e.g., or a structure on the sensing target 204) may be obtained through the transmission of reference signal (RS) resources 208 to the sensing target 204 and the subsequent measurement of the accumulated time profile and/or frequency profile of the received RS metrics. For example, such RS metrics may include reference signal received power (RSRP), reference signal received power per path (RSRPP), reference signal carrier phase (RSCP), combinations of the same, or the like.

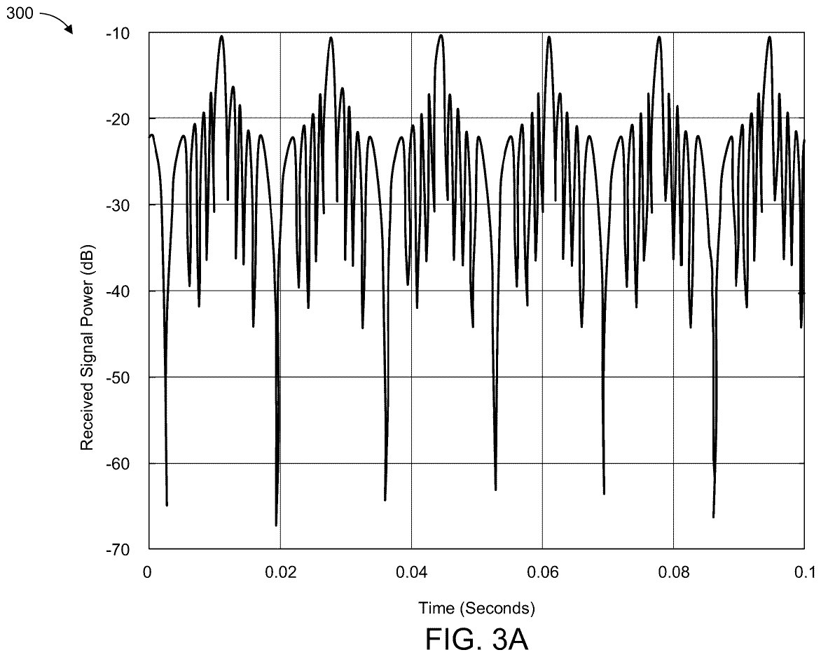

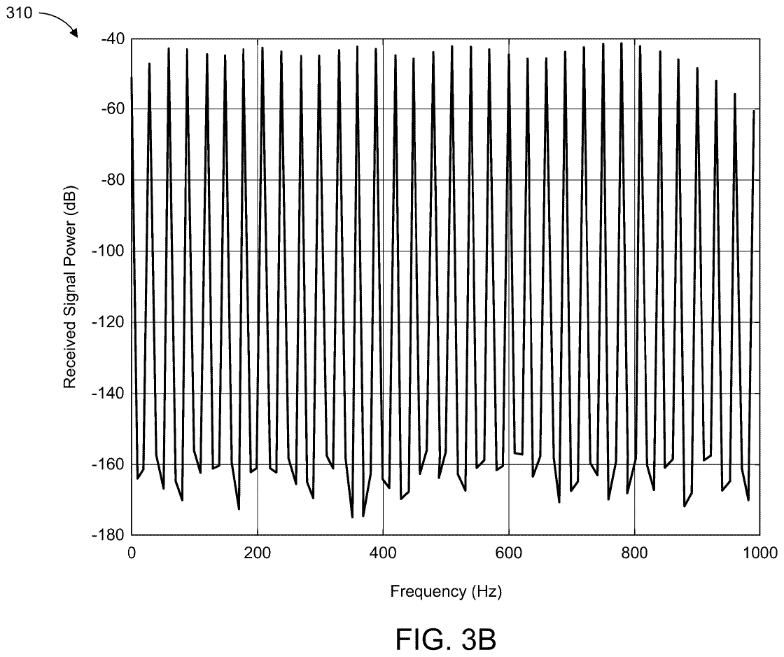

FIGS. 3A-B are illustrative charts of RS power delay profiles, in accordance with certain embodiments.

In one example, a UAV is the sensing target (e.g., UAV 204 of FIG. 2) and has a single propeller blade with a rotation frequency of 30 Hz, a carrier frequency of 15 GHz, and a propeller blade length of 5λ, where λ corresponds to the carrier wavelength.

As shown in FIG. 3A, the WTRU may determine a RS power delay time profile 300 based on measurements of received signal over time. As shown in FIG. 3B, the WTRU may determine a RS power delay frequency profile 310 based on measurements of received signal over a spectrum of frequencies. For example, the peaks in the RS power frequency profile may exist at the UAV propeller blade rotation frequency of 30 Hz and its harmonics (e.g., 60 Hz, 90 Hz, or the like).

In some ISAC approaches, the transmitter (e.g., gNB 202 of FIG. 2) may send a consecutive number of RS resources towards a sensing target (e.g., UAV 204 of FIG. 2) that are reflected towards a sensing target (e.g., WTRU 206 of FIG. 2) to capture a MD signature of the target. For example, the receiver may then accumulate measurements (e.g., within a measurement time window) of the reflected RS resources (e.g., RSRPP, RSCP, signal-to-interference-plus-noise ratio (SINR), or the like) to extract RS metric time profiles and/or frequency profiles.

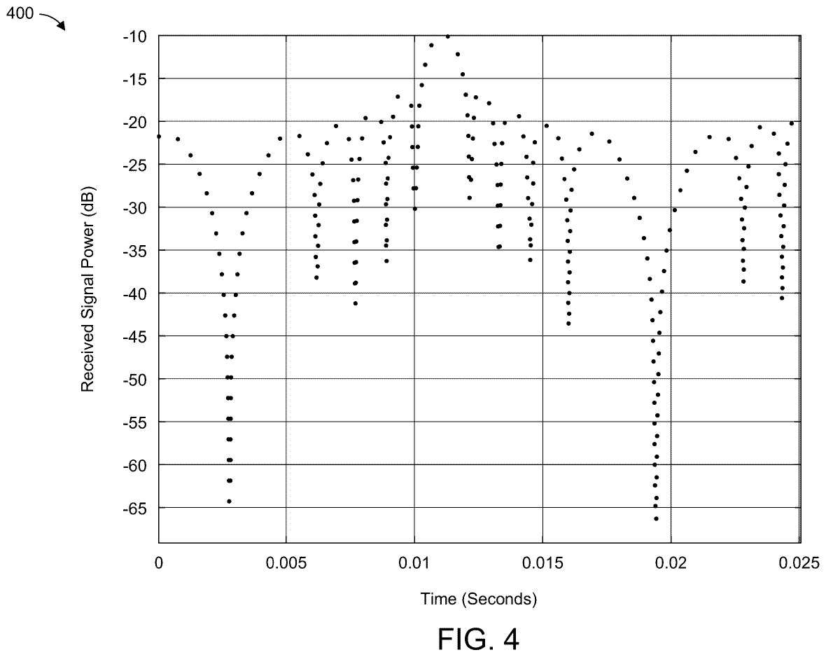

FIG. 4 is an illustrative chart 400 of accumulated RS resource measurements, in accordance with certain embodiments.

As shown in FIG. 4, measurements of the received RS from the target performed during individual measurement time windows may be aggregated to form a power delay profile 400 of the reflected RS. For example, the RS periodicity and/or repetition factor of the resource may control the sampling time of the MD motion in the time domain (e.g., the time between each two consecutive measurement samples).

In accordance with certain embodiments of the present disclosure, relevant terminology and general WTRU behaviors are described as follows.

In the present disclosure, a wireless network may include at least one of an access and mobility management function (AMF), location management function (LMF), sensing function (SF), gNB, TRP, next generation radio access network (NG-RAN), combinations of the same, or the like. It is understood that a wireless network may include any suitable components and devices, including, for example, any of one or more base stations, one or more WTRUs, or any combination thereof. It will be further understood that a component or device that is part of the wireless network can be referred to as communicating with the wireless network when it is communicating with any one or more other components or devices of the wireless network. For example, reference to a WTRU, which is part of the wireless network, transmitting or receiving signals to or from the wireless network refers to the WTRU transmitting or receiving signals, respectively, to or from any other component or device (e.g., another WTRU) of the wireless network.

An LMF is a non-limiting example of a node or entity (e.g., network node or entity) that may be used for or to support positioning or sensing. Other nodes and/or entities, such as a SF, may be substituted for LMF and still be consistent with the present disclosure.

The WTRU may receive one or more configured thresholds from the network (e.g., LMF, gNB, or the like). “Preconfigured” and “configured” may be used interchangeably in the present disclosure.

A WTRU location may be expressed in terms of altitude, latitude, geographic coordinate, local coordinate, combinations of the same, or the like.

In the present disclosure, a timestamp may be indicated by at least one of: absolute time; relative time (e.g., in seconds) compared to a reference time; single frequency network (SFN) index; slot index; frame index; subframe index; symbol index; combinations of the same; or the like. Examples of “absolute time” may include at least one of: coordinated universal time (UTC) time, global navigation satellite system (GNSS) time, locally defined absolute time (e.g., long-term evolution (LTE) or new radio (NR) Time), combinations of the same, or the like.

In the examples described herein, the WTRU may receive configurations for a measurement time window including at least one of: a duration (e.g., expressed in terms of seconds, number of symbols, number of slots, number of frames, number of subframes); a start time; an end time; combinations of the same; or the like. The start time and/or end time may be expressed in terms of absolute time, system time, relative time with respect to a reference time indicated by the network or determined by the WTRU, serving node function (SNF index), slot index, symbol index, frame index, subframe index, combinations of the same, or the like.

The WTRU may receive more than one configuration of a measurement time window. For example, each received configuration may be associated with an index. Further, for example, a measurement time window may be initiated based on a trigger sent by the network. Additionally, for example, the WTRU may receive a command (e.g., via downlink control information (DCI)) to initiate a measurement time window indicated by a configuration index. Moreover, for example, the WTRU may determine to initiate the measurement time window after a configured duration following reception of the command (e.g., N symbols, N slots, N frames, N seconds, or the like). Also, for example, the WTRU may receive an activation or deactivation command (e.g., via DCI or medium access control-control element (MAC-CE)) from the wireless network to activate or deactivate the time window.

The WTRU may send a request to the network for configuration including downlink RS (DL-RS) and uplink RS (UL-RS) configurations. For example, the request may include requests for measurement information, processing window, transmission window, combinations of the same, or the like. Further, for example, the request may be sent using radio resource control (RRC), MAC-CE, physical uplink shared channel (PUSCH), physical uplink control channel (PUCCH), uplink control information (UCI), low latency processing (LLP) message, combinations of the same, or the like. Moreover, for example, the WTRU may send an acknowledgement of the grant message received through PUSCH or PUCCH.

The WTRU configuration may include one or more conditions associated with one or more WTRU behaviors. For example, the WTRU may determine its behavior based on the one or more conditions included in the WTRU configuration. Further, for example, the WTRU may be configured with conditions and associated WTRU behaviors through RRC, LLP message, or the like. Moreover, for example, the WTRU may, based on the configuration information, determine an action based on a given set of conditions.

In some examples, the WTRU may measure the DL-RS within or outside an active bandwidth part (BWP). In some examples, the WTRU may transmit the UL-RS within or outside the active BWP. In some examples the WTRU may include, in addition to measurements on the DL RS, cell-related measurements such as those based on synchronization signal block (SSB), channel state information RS (CSI-RS), demodulation RS (DMRS), combinations of the same, or the like.

In some examples, the WTRU may isolate the line-of-sight (LOS) component based on an indication from a wireless network. For example, a LOS indicator may indicate the likelihood of the presence of a LOS path between a transmit/receive point (TRP) and WTRU or along a DL-RS. Further, for example, the LOS indicator may be a hard (e.g., 1 or 0) or soft (e.g., 0, 0.1, 0.2, . . . 1) indicator. Moreover, for example, the LOS indicator may be associated with a TRP or PRS resource ID (e.g., index). Also, for example, the WTRU may receive the LOS indicator from the network per-TRP or per-resource ID. In some examples, the WTRU may determine the LOS indicator per-TRP or per-resource ID based on measurements, e.g., performed by the WTRU. Additionally, for example, the WTRU may determine the presence of a LOS path based on sensing assistance information for measurements, e.g., received from the wireless network.

In the present disclosure, “dwelling time” may refer to the overall duration or periodicity of the transmitted RS signals or sequence of RS signals (e.g., expressed in terms of number of orthogonal frequency division multiplexing (OFDM) symbols, time slots, time physical resource blocks (PRBs), symbols, frames, subframes, or the like). For example, the dwelling time may impact the sensing performance (e.g., specific accuracy of RS measurement, signal-to-noise ratio (SNR)) at the receiver of a sensing task. Further, for example, dwelling time may refer to the total measurement time of the MD motion profile.

In some examples, the WTRU is configured by the network via RRC signaling or LTE-positioning protocol (LPP) messaging to measure the reflected RS signal or sequence of RS signals within a measurement time window. For example, the configuration of the time window may include at least one of: a start time, end time, duration (e.g., expressed in number of OFDM symbols, time slots, time PRBs, or the like), allocated RS resources within the measurement time window, repetition of the measurement time window, combinations of the same, or the like.

In some examples, the configured measurement time window may be shorter and/or longer than the measured and/or estimated dwelling time that is associated with a sensing target task (e.g., MD motion time profile). In such examples, the WTRU may determine a measurement time window length mismatch.

For example, when the measurement time window is shorter than the dwelling time, the WTRU may determine a measurement time window short length mismatch. Further, for example, a measurement time window short length mismatch may lead to at least one of: a high uncertainty range in the measured target sensing metric (e.g., MD frequency) being greater than a configured threshold, an accuracy being less than a configured threshold, a SNR being greater than a configured threshold; combinations of the same; or the like.

For example, when the measurement time window is longer than the dwelling time, the WTRU may determine a measurement time window short length mismatch. Further, for example, a measurement time window short length mismatch may lead to at least one of: more RS signaling overhead to the network; more power consumption at the WTRU; more memory or buffer size used at the WTRU to accumulate the measurements of the sequence of RS signals; combinations of the same; or the like.

In some examples, the WTRU may be configured to measure and report over bundled measurement time windows, e.g., based on determining a measurement time window short length mismatch.

In some examples, the WTRU may be configured to measure and report over one or more segments of the measurement time window (e.g., half of the measurement time window, quarter of the measurement time window, or the like), e.g., based on determining a measurement time window mismatch.

In the present disclosure, “target MD profile” may refer to the frequency transform (e.g., using fast Fourier transform (FFT), short FFT, or any other frequency transformation) of the time profile of an RS metric (e.g., RSRP, RSCP, RSRPP, or the like) measured within a measurement time window. Additionally, or alternatively, “target MD profile” may refer to the frequency transform of the time profile of the measured sensing metric of the target (e.g., radar cross section (RCS)). For example, the target MD profile may comprise at least one of: MD frequency locations (e.g., discrete locations in the form of fundamental frequency and its harmonics, continuous locations, or the like); amplitudes; phases; combinations of the same; or the like.

In the present disclosure, “MD magnitude” may refer to RS signal power at the MD frequency in the RS frequency profile. For example, the MD magnitude may be expressed by the wireless network in terms of statistical values including the average, maximum value, and/or minimum value of the RS signal power at each MD frequency. Further, for example, the WTRU may use such statistical values to validate its measurements and/or remove any outlier measurements.

In accordance with certain embodiments of the present disclosure, constraints on the dwelling time are described as follows.

In some examples, the dwelling time T_{D} is constrained by a minimum dwelling time. For example, the minimum dwelling time T_{D,min} may be 2/f_{MD}, where f_{MD} is the lowest MD frequency of the target.

In some examples, the dwelling time T_{D} is constrained to be equal to n/f_{MD}, where n is an integer value greater than or equal to 2. For example, if the n is a non-integer value, the WTRU may determine an incorrect frequency resolution, which may lead to inaccurate MD frequency estimation.

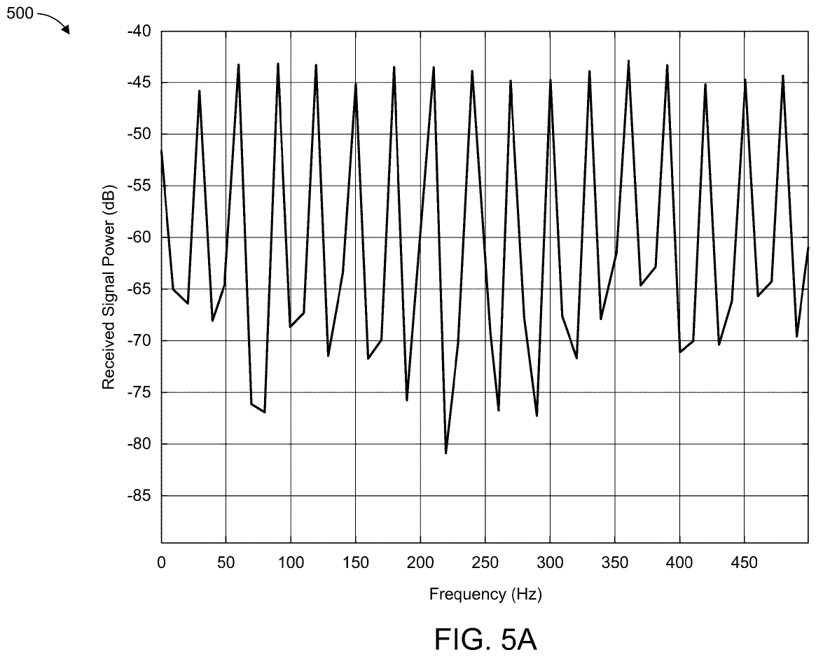

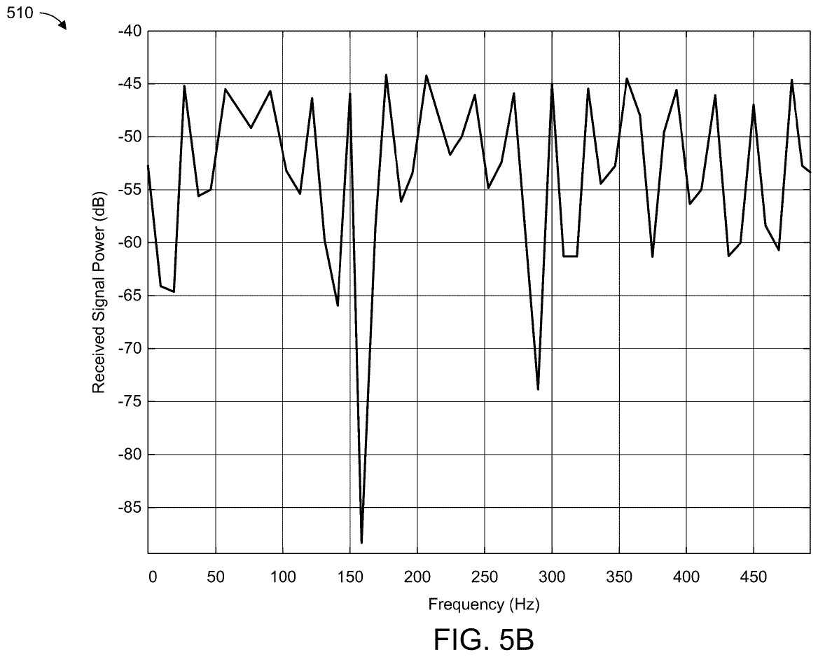

FIGS. 5A-B are illustrative charts of RS power frequency responses at different dwelling times, in accordance with certain embodiments.

As shown in FIG. 4A, a frequency response 400 determined by a WTRU with a dwelling time of length 3/f_{MD} may determine an accurate frequency resolution and lead to accurate MD frequency estimation. As shown in FIG. 4B, a frequency response 410 determined by a WTRU with a dwelling time of length 3.2/f_{MD} results in inaccurate frequency resolution and may lead to inaccurate MD frequency estimation.

In some examples, the dwelling time affects the received SNR of the MD signature. For example, the received SNR may increase as the dwelling time increases.

In connection with adaptive sensing time measurements, methods for dwelling time measurements of sensing targets are described as follows.

In some ISAC approaches, the ISAC transmitter (e.g., TRP, gNB) may send a sequence of RS resources towards a target for a sensing task (e.g., MD signature measurement). For example, the ISAC receiver (e.g., WTRU) may receive the reflected RS from the target and measure the corresponding RS metric (e.g., RSRP, RSCP, SINR, or the like) over a measurement time window. However, the measurement time window may not meet the requirement of the dwelling time needed to achieve the sensing task associated with the target. In some examples, the length of the measurement time window may be longer or shorter than a desired dwelling time. In such examples, the reported sensing measurements (e.g., MD signature) may have high uncertainty, low accuracy, low SNR, combinations of the same, or the like.

Current approaches lack support for measuring a RS metric (e.g., RSRPP, RSCP, SINR, or the like) time profile and/or frequency profile that is reflected from a sensing target. Furthermore, such approaches lack support for measurement and/or estimation of dwelling time, resulting in deficiencies in target motion and/or sub-motion sensing. Thus, an approach that has the capability to determine and report a mismatch between a dwelling time (e.g., required and/or desired for a particular sensing task) and a configured measurement time window based on a measured RS-metric profile is desired.

Accordingly, systems and methods are described as follows for adaptive measurement time windows for sensing. In some embodiments, a WTRU (e.g., WTRU 102 of FIGS. 1A-D, WTRU 206 of FIG. 2) is configured with a number of consecutive RS resources to use for performing and reporting sensing measurements. In some embodiments, the WTRU detects a length mismatch (e.g., short mismatch or long mismatch) between a measurement time window and an estimated and/or measured dwelling time, e.g., based on RS measurements over the configured measurement time window and/or configured thresholds. In some embodiments, the WTRU determines and reports a preferred measurement time window (e.g., including bundled and/or segmented consequent measurement time windows). In some embodiments, the WTRU sends a report to the network that contains the detected length mismatch and the corresponding RS measurements (e.g., taken during the measurement time window and/or the preferred measurement time window).

In certain representative embodiments, the WTRU may perform at least one of the following steps: receiving a configuration from a wireless network to start a sensing task related to a sensing target; receiving and measuring sensing RSs that are reflected from the sensing target and determining a measurement time window length mismatch; determining to bundle and/or segment one or more measurement time windows and measure the RSs that are reflected from the target within the bundled and/or segmented measurement time windows; reporting dwelling time measurements, indications of the measurement time window length mismatch, and/or preferred measurement time window; combinations of the same; or the like.

In certain representative embodiments, the WTRU receives a configuration from a wireless network to start a sensing task related to a sensing target. For example, the configuration may be received via RRC signaling, MAC-CE or DCI. Further, for example, the configuration may include at least one of the following: a sensing RS (e.g., positioning RS (PRS) or equivalent) configuration; sensing RS measurement and/or reporting configurations; sensing assistance information for the sensing target; combinations of the same or the like.

For example, the sensing RS measurement and/or reporting configurations may include at least one of the following: metrics to be measured, e.g., RSRP, RSRPP, RSCP, angle of arrival (AoA), MD, dwelling time associated with the sensing target task, or the like; a default and/or first measurement configuration; criteria for dwelling time measurement and/or estimation (e.g., based on the measurement accuracy, received SINR, uncertainty range, or the like); thresholds for detection of measurement time window length mismatches (e.g., short and/or long); thresholds for reporting, updating, or the like; triggering conditions for measurement time window segmentation and/or bundling (e.g., detection of length mismatch between the measurement time window and the dwelling time); a RS metric peak detection configuration (e.g., based on a minimum threshold difference between a point and its neighbor points, based on a gradient method, or the like); combinations of the same; or the like.

For example, a default and/or first measurement information may indicate at least one of the following: a default window size; list of bundling parameters for concatenation (e.g., 1, 2, 4, . . . ); expected and/or first MD frequency; range of MD frequencies; initial list of times and/or angles for measurement; initial number of periodic measurements; combinations of the same; or the like.

For example, sensing assistance information may include at least one of: a sensing target identifier, sensing target profile information, sensing target positioning information, combinations of the same, or the like.

In certain representative embodiments, the WTRU receives and measures sensing RSs that are reflected from the sensing target and determines a measurement time window length mismatch. For example, the WTRU may determining a measurement time window length mismatch based on at least one of the following: a difference between the configured measurement time window and the measured and/or estimated dwelling time that is associated with the sensing target task is greater than a configured threshold; a measured SINR of the RS metric time profile and/or frequency profile is less than a configured threshold; a measured number of peaks in the RS metric time profile and/or frequency profile is less than a configured threshold; a measured peak to average power ratio of the received RS metric time profile and/or frequency profile is less than a configured threshold; an uncertainty range in the frequency of the peaks of the RS metric frequency profile is greater than a configured threshold; a measured RS metric (e.g., RSRP, SINR, RSRPP, bandwidth, or the like) is less than a configured threshold; combinations of the same; or the like.

Such systems and methods enable the WTRU to adapt measurement and reporting behavior based on requirements for dwelling time associated with each target sensing task. For example, adaptations to the measurement time window may reduce the signaling overhead incurred by reporting and/or updating the report at incorrect time intervals. Further, for example, adaptations to the measurement time window may reduce the signaling overhead incurred by reconfiguration to increase received SNR and/or measured accuracy of the sensing task output.

In certain representative embodiments, the WTRU receives a configuration comprising at least one of the following: WTRU capability information; RS configurations; target measurement time window length mismatch detection triggering conditions; measurement configurations for measurement time window length mismatch detection; combinations of the same; or the like.

In some embodiments, the WTRU receives and decodes a first network request, e.g., received through RRC signaling, to provide capability information. For example, the WTRU may receive and decode this first network request following a random-access procedure. Further, for example, the WTRU may prepare a capability information message including information related to sensing capabilities such as scatterers and clutter identification. Moreover, for example, the information contained in the WTRU capability information message may include one or more of the following: sensing processing capabilities, e.g., inverse frequency transform capabilities, maximum number of samples, or the like; sensing frequency ranges; sensing bandwidth; sensing modes, e.g., monostatic, bistatic, or the like; sensing priorities; sensing spatial resolution; sensing time resolution; support of AoA determination and related angular resolution; sensing doppler resolution; reflectivity sensitivity, e.g., minimum power, SNR, absolute amplitude, or the like, for the reflections to be detectable by the WTRU; support of carrier phase measurements and related phase resolution; support of half-duplex or full-duplex for monostatic sensing; related parameters, e.g., frequency range, maximum allowed transmit power for sensing, or the like; combinations of the same; or the like.

In some embodiments, the WTRU sends the WTRU capability information message through RRC signaling, e.g., over PUSCH. In some embodiments, the WTRU capability information is then used by the wireless network to optimize its configuration and resource allocation for sensing.

In some embodiments, the WTRU receives a RS configuration for DL-RS and/or UL-RS including one or more of the following parameters: index (ID); number of resources or resource sets; resource set IDs; sequence IDs; periodicity; type; repetition factor; comb pattern; comb size; spatial relation for transmission; spatial relation for reception; quasi colocation (QCL) information; subcarrier spacing; number of spatial layers; start and/or end time for transmission; time window; power related information; beam related information; combinations of the same; or the like. For example, the DL-RS may include CSI-RSs, phase tracking reference signals (PTRSs), PRSs, tracking reference signals (TRSs), synchronization signal blocks (SSBs), dedicated sensing RSs, combinations of the same, or the like. Further, for example, the UL-RS may include sounding reference signals (SRSs), SRS for positioning (SRSp), dedicated sensing RSs, combinations of the same, or the like.

In some embodiments, the WTRU may receive triggers for initiating the procedure to measure the RSs reflected from the target and detect the measurement time window mismatch as part of the first configuration from the network (e.g., LMF, gNB). For example, the WTRU may monitor for one or a combination of target profiles. Further, for example, the WTRU may be triggered to sense reflections for one target or a set of combined targets using time-based, event-based, location-based, mobility-based, and quality of service (QoS)-based triggers, or other predefined criteria.

In some embodiments, the WTRU, upon the detection of triggers, sends a request to the network (e.g., LMF, gNB) to initiating the measurement time window length mismatch detection using profile measurement (e.g., RS profile, RCS profile, or the like). For example, the WTRU may explicitly initiate measurement time window length mismatch detection via uplink signaling, e.g., RRC signaling, MAC-CE, UCI, or reference signal transmissions (e.g., SRS transmissions). Further, for example, the WTRU may implicitly initiate measurement time window length mismatch detection via selection of certain uplink resources, e.g., resources related to physical random-access channel (PRACH), PUCCH, PUSCH, spatial relation info, or the like.

In some embodiments, the WTRU receives a first configuration from the wireless network to initiate measuring the RS reflected from the target within the configured measurement time window using profile measurements (e.g., RS profile, RCS profile, or the like) and reports to the wireless network based on the details provided in the initial configuration.

In some embodiments, the WTRU requests for other target profiles and/or scatterer profiles (e.g., measured at different angles, frequency bands, or the like) from the wireless network if the sensing target and/or scatterer measurements are not satisfactory, e.g., below a particular sensing resolution or having unmatched patterns.

In some embodiments, the WTRU receives a second configuration from the wireless network to assist the WTRU with the sensing target reflection measurements. For example, this second configuration may include a different measurement time window configuration or additional information for the WTRU to assist with (e.g., more granular information than included in the first configuration).

In some embodiments, the WTRU receives a configuration from the wireless network that includes an indication to start a sensing task that is related to a sensing target (e.g., target localisation, tracking, or the like). For example, the WTRU may receive the configuration via RRC signaling, MAC-CE, DCI, or the like. Further, for example, the configuration may include a sensing measurement task within a measurement time window and corresponding triggers including at least one of the following: a target sensing task configuration; reference signal information and/or DL reference signal configuration; metrics to be used for target sensing task measurement, e.g., in relation to reference signals; default/first measurement configurations; dwelling time measurement criteria; thresholds for measurement time window match/mismatch detection, reporting, report update, and termination; measurement time window configuration; types of RS metric profiles to be measured for the target sensing task measurement; reporting configuration; RS path delay and/or time of arrival (ToA) measurement configuration; RS metric peak detection configuration; combinations of the same; or the like.

For example, the target sensing task configuration may include at least one of the following: an indication (e.g., a flag) to activate and/or deactivate the sensing measurements; a time window for the target sensing task measurement procedure; triggers for initiating and/or terminating the target sensing task measurement procedure; target sensing task measurement reporting information; combinations of the same; or the like.

For example, the time window for the target sensing task measurement procedure may include a start time; a minimum and/or maximum duration; a number of measurement occasions for update and termination; combinations of the same; or the like.

For example, triggers for initiating and/or terminating the target sensing task measurement procedure may include at least one of the following: time-based triggers, e.g., initiating and/or terminating target sensing task measurements at predefined intervals for periodic monitoring; event-based triggers, e.g., initiating and/or terminating target sensing task measurements when certain signal parameters such as SINR fall below configured thresholds; location-based triggers, e.g., when the WTRU enters and/or leaves a certain geographical area, or when the WTRU detects proximity to a particular target or location; mobility-based triggers, e.g., accounting for the WTRU being stationary or mobile; QoS-based triggers, e.g., based on sensing accuracy or resolution, positioning-based QoS (e.g., positioning resolution in meters), and/or reliability-based QoS (e.g., missed detection and false alarm percentages); combinations of the same; or the like.

In one example, the WTRU is triggered to initiate and/or terminate a target sensing task if the measured WTRU location (e.g., using RAT-dependent and/or RAT-independent methods) and the configured target location is less than a particular threshold.

In one example, the WTRU is triggered to activate and/or deactivate a target sensing task if the measured WTRU velocity is greater than a particular threshold value and/or within a range of threshold values. In one example, the WTRU is triggered to activate and/or deactivate a target sensing task if the difference between the measured WTRU velocity and the configured target velocity is below a threshold value.

For example, target sensing task measurement reporting information may include at least one of the following: a reporting type, e.g., periodic, semi-periodic, aperiodic; reporting thresholds, e.g., conditions for the WTRU to report target sensing task measurement information based on changes in the target sensing task or other predefined criteria; reporting content and format, e.g., raw or processed data, statistical or instantaneous data, or the like; a timing reporting granularity factor; reporting resources, e.g., uplink resources such as transmission power, resource blocks, and scheduling information; error handling and resensing (e.g., repeat sensing) strategies; combinations of the same; or the like.

In one example, the report content is based on the detected sensing measurement event, e.g., target-only report, target and environmental object report, target true match/mismatch detection report, resolved/unresolved target report, or the like.

In one example, the timing reporting granularity factor is configured based on the sensing measurement event detected. For example, the target true match detection corresponds to timing reporting granularity factor x and target mismatch detection corresponds to timing reporting granularity y. In one example, the timing reporting granularity is configured based on measured RS metrics, e.g., RSRP, RSRPP, channel impulse response (CIR), SINR, reference signal received quality (RSRQ), or the like.

For example, reference signal information and/or DL-RS configuration may include at least one of the following: reference signal types, e.g., PRS; resource sets; time and/or frequency characteristics such as pattern and density; cover codes; periodicity, time gap, and comb size; power settings; beamforming and/or precoding related information (e.g., beam IDs, transmission configuration indicator (TCI) settings, QCL info, or the like).

For example, metrics to be used for the target sensing task measurement, e.g., in relation to reference signals, include at least one of the following: RSRP; RSRPP; RSRQ; SINR; channel quality indicator (CQI); rank indicator (RI); precoding matrix indicator (PMI); timing advance (TA); MD frequency; combinations of the same; or the like.

For example, default/first measurement configurations may include a default window size; list of bundling parameters for concatenation (e.g., 1, 2, 4, . . . ); an expected/first MD frequency; a range of MD frequencies; initial list of time and/or angle for measurements; initial number of periodic measurements; combinations of the same; or the like.

For example, dwelling time measurement criteria may include at least one of the following: a criteria ID, which may be assigned to the sensing task ID or the target ID; a type and number of RS resources that are allocated to measure the dwelling time; a type of RS measurement that is used to measure the dwelling time (e.g., RSRPP, RSCP, RS metric profile, RS metric profile type, or the like); a measurement and/or estimation formula expressed as a function of different combined metrics, statistical measurements, or the like; combinations of the same; or the like.

For example, thresholds for measurement time window length mismatch detection, reporting, report update, and termination include at least one of the following: a static threshold to determine the detection of sensing measurement events (e.g., the difference between a measured and configured target profile is greater/less than a threshold, the difference between the measured and configured RS profile, is greater/less than a threshold); measurement accuracy thresholds; update thresholds; termination thresholds; combinations of the same; or the like.

For example, the measurement time window configuration may include at least one of the following: time window information, e.g., a start time and/or end time (e.g., measured relative to first reflected path time, line of sight (LoS) path time, target configured ToA, or the like); a number of samples per window, e.g., a number of RSs received during a time window required to perform sensing measurements; time, frequency, and power allocations of the time window, e.g., a set of resources allocated for the RSs in a time window (e.g., number of frames, number of symbols, PRBs, slots, or the like); repetition information of a window, e.g., periodic, aperiodic, semi-persistent, or the like; length (e.g., absolute, relative to the target size, or the like); triggers for activating, deactivating, and/or updating the length of bundling and/or segmentation of the measurement time windows; bundling and/or segmentation configurations that may include one or more of the following:

For example, triggers for activating, deactivating, and/or updating the length of bundling and/or segmentation of the measurement time windows may include at least one of: event-based triggers; time-based triggers; location-based triggers; mobility-based triggers; QoS-based triggers; combinations of the same; or the like.

For example, the bundling and/or segmentation configurations may include at least one of the following: thresholds for activating, deactivating, and updating of bundling and/or segmentation of measurement time windows; selection criteria for the bundled and/or segmented measurement time windows; bundling and/or segmenting criteria of the RS measurements within one or more measurement time windows; criteria to determine the length of the bundled measurement time windows and/or the segments within a measurement time window (e.g., based on the dwelling time measurement); combinations of the same; or the like.

For example, types of RS metric profiles to be measured for the target sensing task measurement include at least one of: RS metric frequency profile information, e.g., relative received amplitude (e.g., and phase) at different frequencies and/or PRBs; a RS metric angular profile, e.g., relative received power at a set of relative AoAs and/or angles-of-departure (AoDs); RS metric time profile information, e.g., relative received amplitude and (e.g., and phase) at different time slots and/or PRBs.

For example, the reporting configuration may include at least one of the following: allocated reporting of uplink control and/or data channels: periodicity of reporting information; report content; combinations of the same; or the like.

For example, allocated reporting of uplink control and/or data channels may include at least one of: a number of allocated channels; a type of allocated channels; a type of allocation (e.g., uplink channel x is allocated to report y, uplink channel x is allocated to periodic reporting, uplink channel x is allocated to report on event y, or the like; combinations of the same; or the like.

For example, the periodicity of reporting information may include at least one of: a type (e.g., periodic, aperiodic, semipersistent, or the like); a period of time between two successive reports (e.g., periodic and semipersistent); report types associated to each periodicity type (e.g., report x is periodic, while report y is semipersistent, or the like); combinations of the same; or the like.

For example, report content may include detected events and measurement time window information. Further, for example, measurement time window information may include at least one of the following: a location of the bundled and/or segmented time windows, a length of the bundled and/or segmented measurement time windows, a number of the bundled and/or segmented measurement time windows, combinations of the same, or the like.

For example, RS path delay and/or ToA measurement configurations may include at least one of the following: a timing of each RS path reported relative to the path timing used for determining reference signal time difference (RSTD) or WTRU receive-transmit (Rx-Tx) time difference; a timing of each RS path reported relative to the ToA and/or path delay of the RS that is reflected from a reference target (e.g., tree, building, or the like); a timing of each RS path reported relative to the ToA and/or path delay of the first path; a timing of each RS path reported relative to the ToA and/or path delay of an LoS path; combinations of the same; or the like.

For example, the WTRU may be configured to determine the peak in the RS metric measured over a configured measurement time window based on at least one of the following: the maximum value of the measured RS values over the measurement time window; the measured RS metric that is greater than the previous and following measured RS metric such that the difference between the current RS metric and the previous and/or following RS metric is greater than a difference threshold value; the value of the RS metric gradient and/or slope value over a measurement time window; combinations of the same; or the like. For example, the WTRU determines that the RS peak is at the RS measurement x based on: the RS metric gradient value at x being zero or below a threshold minimum value, the RS metric gradient value at x−1 being a positive value, and the RS metric gradient value at x+1 being a negative value.

In certain representative embodiments, the wireless network provides the WTRU with sensing assistance information that includes parameters to aid in performing sensing measurements as part of the configuration. For example, the WTRU may receive the assistance information associated with the sensing target from the wireless network. Further, for example, the WTRU may receive the sensing assistance information semi-statically (e.g., via LPP or RRC messages) and the assistance information may include at least one of the following: a sensing target identifier (ID), association to a sensing measurement event ID, sensing target profile information, sensing target positioning information, sensing target mobility information, sensing target MD profile information, validity time for sensing assistance information, combinations of the same, or the like.

For example, the sensing target ID may be associated to a target type (e.g., human target, vehicles, rocks, or the like) and/or target location. In some embodiments, the IDs for a target are selected from different pools. In some embodiments, all targets associated with a type have IDs from the same pool.

For example, a sensing target ID may be the same as or a part of a sensing measurement event ID. Further, for example, the sensing measurement event ID may be part of the target ID. Moreover, for example, a single target ID may be associated to one or more sensing measurement event IDs. Additionally, for example, multiple target IDs may be associated to one or more sensing measurement event IDs.

For example, sensing target profile information may include at least one of the following: RS metric-frequency profile information, e.g., relative received amplitude (e.g., RSRP, RSRPP, SINR, or the like) and/or phase (e.g., RSCP), at different frequencies and/or PRBs; a RS metric angular profile, e.g., relative received power at a set of relative AoAs and/or AoDs; a RS metric time profile information, e.g., relative received amplitude and/or phase at different time slots and/or PRBs; RCS frequency profile information, e.g., relative target RCS amplitude and/or phase at different frequencies and/or PRBs; RCS angular profile, e.g., relative target RCS at a set of relative AoAs and/or AoDs; RCS time profile information, e.g., relative target RCS amplitude and/or phase at different time slots and/or PRBs; MD profile, e.g., relative target MD amplitude and/or phase of the target configured MD frequency and/or range of frequencies (e.g., discrete or continuous range) that correspond to the target sub-motion (e.g., vibration, rotation, or the like); combinations of the same; or the like.

For example, sensing target positioning information may include at least one of the following: absolute positioning information, e.g., target coordinates (x,y,z); relative positioning information, e.g., with respect to the coordinates and/or the orientation of the TRP and/or the WTRU; a coarse location, e.g., location is given as an area defined between certain coordinates, cell IDs, sector IDs, or the like; combinations of the same; or the like. Further, for example, the WTRU may receive the WTRU/TRP positioning and/or orientation information to assist the WTRU to calculate the target location relative to the WTRU/TRP locations.

For example, sensing target mobility information may include at least one of the following: absolute mobility information (e.g., target velocity, doppler frequency, or the like); relative mobility information (e.g., with respect to the WTRU and/or TRP velocity); an uncertainty range (e.g., velocity and/or doppler frequency); combinations of the same; or the like.

For example, validity time for sensing assistance information may include a total time duration when the sensing assistance information that is provided by the network may be associated to the target. Further, for example, the validity time may be configured in terms of number of symbols, slots, frames, subframes, seconds, or the like.

In accordance with certain embodiments of the present disclosure, a measurement framework for multiple reference signals is described as follows. In some embodiments, after receiving the RS configuration, the target sensing task time window configuration, and/or the sensing assistance information, the WTRU may receive the RS resources and an indication from the network to initiate the target sensing task. For example, the measurement framework for multiple reference signals may include at least one of the following WTRU actions: measurements of the reflected RS from the target; determination of resolved paths; RS metric profile measurements of the resolvable paths; measurement of difference between profiles; determination of reflected RS from the target; measurement of reflected RS time profiles; combinations of the same; or the like.

In certain representative embodiments, the WTRU is configured to perform measurements of the received set of sensing RSs, e.g., CSI-RS, PRS, SSB, or the like, to determine the difference between the configured measurement time window and the measured and/or estimated dwelling time. For example, the WTRU may receive a set of RSs, e.g., from a single TRP or multiple TRPs, with configured time, frequency, space, and power resource allocations (e.g., frames, sub-frames, slots, PRBs, single or multiple antenna ports, or the like).

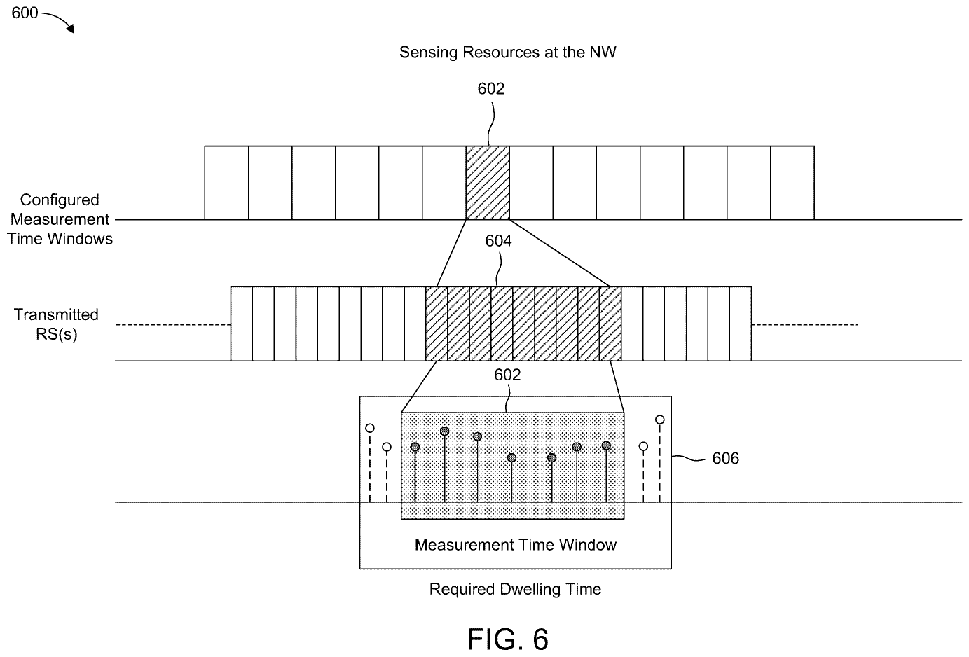

FIG. 6 is an illustrative diagram 600 of performing measurements of multiple transmitted RSs within a measurement time window, in accordance with some embodiments.

As shown in FIG. 6, the WTRU may perform sensing measurements during a configured measurement time window 602. For example, during the measurement time window 602, the WTRU may receive multiple transmitted RSs 604 and perform measurements of the RSs 604. However, the required dwelling time 606 associated with the sensing task may include measurements taken outside of the measurement time window 602. Further, for example, the WTRU may determine that there is a mismatch between measurement time window 602 and the required dwelling time 606.

In some embodiments, the WTRU may use the received RSs 604 during the configured time window 602 to perform at least one of the following measurements: angle measurements, e.g., AoA; temporal measurements, e.g., ToA, time difference of arrival (TDoA); power measurements, e.g., absolute or relative RSRP, RSRPP, SNR, or the like; mobility measurements, e.g., doppler; uncertainty in doppler measurements (e.g., micro-doppler motion regarded as noise to the doppler motion); RCS profile; combinations of the same; or the like.

In some embodiments, the WTRU is configured to measure doppler. For example, MD may be treated as “noise” in the doppler measurement. Thus, the WTRU may receive a request from the wireless network to report uncertainty in the doppler measurement, e.g., including MD. Further, for example, the WTRU may be configured to use a time window for measuring uncertainty. Moreover, for example, the WTRU may determine that the time window for measuring uncertainty is too short and indicates a preferred window duration. Also, for example, the WTRU may report a cause for the request, e.g., including an estimated dwelling time.

In some embodiments, the WTRU uses the received RSs 604 to perform at least one of the following measurements: channel responses, e.g., CIR, power delay profile (PDP), channel frequency response (CFR), or the like; the number of CIR multipath components, e.g., received within the configured window; the peaks of the obtained power response, e.g., peaks of CIR or PDP detect within the configured window; the average of the obtained power responses, e.g., average power of received signals within the configured window; combinations of the same; or the like.

In some embodiments, the WTRU associates the set of measurements obtained during the configured measurement time window for each target and/or scatterer as the WTRU obtains at least one of the following: a set of accumulated received power measurements; a peak SNR for a specific target over the configured time window; an average SNR for a specific target over the configured time window; a set of accumulated received power measurements; a peak power for a specific target over the configured time window; an average power for a specific target over the configured time window; the angular power characteristics of each received RS for a specific target and/or scatterer, e.g., power angular profile per target; delay power characteristics for a specific target and/or scatterer; e.g., set of PDPs for a specific target; combinations of the same; or the like.

For example, the accumulated received SNR per received multipath component for a specific target and/or scatterer, e.g., out of Nₚ total paths, may be expressed as

$${SNR}_{t} = {\sum }_{i = 1}^{{N}_{p}} {SNR}_{i} .$$

Further, for example, the peak SNR for a specific target over the configured time window may be expressed as

$${SNR}_{max} = {max ( {SNR}_{i} )}_{i = 1}^{{N}_{p}} .$$

Moreover, for example, the average SNR for a specific target over the configured time window may be expressed as S̅N̅R̅=SNRₜ/T_{W}, where T_{W} is the configured measurement time window length. Also, for example, the accumulated power per received multipath component for a specific target and/or scatterer may be expressed as

$${p}_{t} = {\sum }_{i = 1}^{{N}_{p}} {p}_{i} .$$

Additionally, for example, the peak power for a specific target over the configured time window may be expressed as

$${p}_{max} = {max ( {p}_{i} )}_{i = 1}^{{N}_{p}} .$$

Even further, for example, the average power for a specific target over the configured time window may be expressed as p̅ₜ=pₜ/T_{W}.

In some embodiments, the WTRU obtains the set of accuracies for each of the sensing measurements, e.g., accuracy of range estimation, accuracy of velocity estimation, root mean squared error (RMSE) of range estimation, RMSE of velocity estimation, or the like. In some embodiments, the WTRU determines the set of certainty measurements of the obtained angular, temporal, and/or power measurements, e.g., certainty of AoA, ToA, TDoA, RCS profile, or the like.

In some embodiments, the WTRU is configured to determine the resolvable path of the received RS in the temporal and/or the spatial domain (e.g., received at different ToAs and/or AoAs). For example, the WTRU may determine the resolvable path based on determining the received RS metric peaks in the temporal and/or spatial domain. Further, for example, the WTRU may be configured to determine the peaks of the received RS metric (e.g., RSRP, RSRPP, RSCP, or the like) in the temporal and/or spatial domain based on at least one of the following: the maximum value of the measured RS values over the measurement time window; the measured RS metric that is greater than the previous and following measured RS metric such that the difference between the current RS metric and the previous and/or following RS metric is greater than a difference threshold value; a value of the RS metric gradient value over a measurement time window; a difference between two consecutive RS peaks being greater than a configured threshold; combinations of the same; or the like. For example, the WTRU may determine a RS peak at the RS measurement n based on an RS metric gradient value at n being zero or below a threshold minimum value, a RS metric gradient value at n−1 being a positive value, and the RS metric gradient value at n+1 being a negative value,

In some embodiments, the WTRU is configured to determine the temporal resolvable paths of the received RSs at specific spatial configurations (e.g., specific AoA, AoA range, orientation, or the like). In some embodiments, the WTRU is configured to determine the spatial resolved paths of the received RSs at specific temporal configurations (e.g., specific ToA, ToA range, or the like).

In some embodiments, the WTRU associates the determined resolvable paths in the temporal and/or spatial domain to the corresponding measured ToA and/or AoA. In some embodiments, the WTRU is configured to assign an ID to each resolvable path in the temporal and/or spatial domains.

In some embodiments, the WTRU starts measuring the RS metric (e.g., RSRP, RSRPP, RSCP, SINR, or the like) profile of the corresponding received RS resource for each resolvable path within a configured spatial and/or temporal measurement time window. For example, the WTRU may associate the RS metric profile of each resolved path to the corresponding measured AoA and/or ToA.

In some embodiments, the WTRU measures the RS metric frequency profile through measurement of the RS metric value (e.g., magnitude, power, phase, or the like) at different frequencies (e.g., frequency PRBs, BWPs, bands, or the like). For example, the WTRU may measure the RS metric angular profile through the measurement of the RS metric value (e.g., magnitude, power, phase, or the like) at different angles that are associated with the RS resource (e.g., AoA, AoD, or the like). Further, for example, the WTRU may measure the RS metric time profile, through measurement of the RS metric value (e.g., magnitude, power, phase, or the like) at different time slots (e.g., time PRBs, symbols, frames, subframes, or the like).

In some embodiments, the WTRU measures the RCS profile of a target and/or the scatterer that corresponds to the received RS resource resolvable paths. For example, the WTRU may measure the RCS frequency profile through measurement of the RCS value (e.g., magnitude, phase, or the like) at different frequencies (e.g., frequency PRBs, BWPs, bands, or the like). Further, for example, the WTRU may measure the RCS angular profile through the measurement of the RCS value (e.g., magnitude, phase, or the like) at resolvable paths of the same RS resource (e.g., AoA, AoD, or the like). Moreover, for example, the WTRU may measure the RCS time profile through measurement of the RCS value (e.g., magnitude, phase, or the like) at different time slots (e.g., time PRBs, symbols, frames, subframes, or the like).

In some embodiments, the WTRU is configured to measure the difference between the measured RS metric resolvable path profile (e.g., RSRPP, RSCP, SINR, or the like) and a configured profile (e.g., target or scatterer RCS profile, combined target-scatterer RCS profile, or the like). For example, the WTRU may measure the difference between two profiles in accordance with the following equation:

$$D = {\sum }_{i = 1}^{M} ( {x}_{i} - {y}_{i} )$$

where xᵢ represents the measured value of the RS metric at the i-th point (e.g., frequency, time, angle, or the like), yᵢ represents the configured profile value at the i-th point, and D represents the sum of the difference between the measured and configured values of the target and/or scatter profile (e.g., combined target-scatter profile). Further, for example, the WTRU may measure the difference between the normalized measured RS metric profile and the normalized configured target and/or scatterer profile (e.g., combined target-scatterer profile) in accordance with the following equation:

$${D}_{N} = {\sum }_{i = 1}^{M} ( {x}_{N , i} - {y}_{N , i} )$$

Moreover, for example, the WTRU may measure the correlation between the measured RS metric profile and the configured target and/or scatterer profile (e.g., combined target-scatterer profile) in accordance with the following equation:

$$C = \frac{{\sum }_{i = 1}^{M} ( {x}_{i} - \overline{x} ) ( {y}_{i} - \overline{y} )}{\sqrt{{\sum }_{i = 1}^{M} {( {x}_{i} - \overline{x} )}^{2} {( {y}_{i} - \overline{y} )}^{2}}}$$

where, x̅ is the average value of the measured RS metric profile over M sampling points (e.g., time, frequency, angle, or the like), y̅ is the average value of the configured target and/or scatterer profile (e.g., combined target-scatterer profile), and C represents the correlation coefficient between the two profiles. Additionally, for example, the WTRU may measure the correlation between the normalized RS metric profile and the normalized configured target and/or scatterer profile (e.g., combined target-scatterer profile).

In some embodiments, the WTRU determines target reflection detection for the resolvable path of the measured RS based on one or more of the following: a measured RS metric (e.g., RSRPP, RSCP, SINR, CIR, or the like) is greater than a configured threshold and/or within a configured threshold range; a difference between the measured RS metric of the resolvable path and configured target RS metric (e.g., RSRPP, RSCP, SINR, CIR, or the like) is less than a configured threshold and/or within a configured threshold range; a correlation between the measured RS metric of the resolvable path and configured target RS metric (e.g., RSRPP, RSCP, SINR, CIR, or the like) is greater than a configured threshold and/or within a configured threshold range; a difference between the measured and configured target position is less than a configured threshold and/or within a configured threshold range; a difference between the measured and configured target RS metric profile is less than a configured threshold and/or within a configured threshold range; a difference between the measured and configured target profile (e.g., RCS profile) is less than a configured threshold and/or within a configured threshold range; a difference between the measured and configured target doppler is less than a configured threshold and/or within a configured threshold range; a difference between the measured AoA and/or ToA of the resolvable path and the configured target AoA and/or ToA is less than a configured threshold and/or within a configured threshold range; a resolvable path is not associated with an RS that has LoS indication between the WTRU and the TRP (e.g., of the wireless network); combinations of the same; or the like.

In some embodiments, the WTRU receives multiple RSs (e.g., from different TRPs and/or a single TRP) associated with the same target and performs configured measurements associated with different excess delay, e.g., with respect to the time of first arrival of the resource associated with the target. For example, when associating multiple RS resources with the same target, the WTRU may consider at least one of the following: an RS resource with the highest RSRP and/or RSRPP measurement; an average RSRP, RSRPP and/or RSCP measurement from the RS resources; an RS resource corresponding to the time of first arrival; combinations of the same or the like.

In some embodiments, the WTRU is configured with multiple measurement occasions and the WTRU may measure the RS metric (e.g., RSRP, RSRPP, RSCP, or the like) associated with the measurement time during each of the multiple measurement occasions. For example, the WTRU may measure the time relative to the (e.g., measured) time of the first measurement instance. Further, for example, the WTRU may determine an RS metric (e.g., RSRP, RSRPP, RSCP, or the like) and excess time delay with respect to the first arrival RS profile, e.g., forming the RS metric time profile.

In some embodiments, the WTRU determines the ΔRS metric (e.g., ΔRSRP, ΔRSRPP, ΔRSCP, or the like) from the RS metric time profile. For example, the WTRU may determine this ΔRS metric as the difference between the RS metric and the configured static threshold (e.g., associated with the RS metric) for each time instance in the RS metric time profile within the configured measurement time window, e.g., forming the ΔRS metric time profile.

In some embodiments, the WTRU determines to convert the ΔRS metric time profile into a ΔRS metric frequency profile (e.g., an amplitude-frequency profile). For example, the WTRU may perform the conversion using a configured method (e.g., FFT). Further, for example, the WTRU may determine to perform the operation based on at least one of the following conditions: a measured ΔRS metric (e.g., average, maximum, minimum, with respect to different time instances) in the RS metric time profile is greater than a configured threshold; a difference between two time instances in the ΔRS metric time profile is less than a configured threshold; a total number of ΔRS metric time samples in the profile is greater than a configured threshold; combinations of the same; or the like.

In some embodiments, the WTRU is configured to perform the frequency transformation based on a WTRU capability. For example, the WTRU may determine the ΔRS metric frequency profile associated with the measurement (e.g., through FFT) based on sensing assistance information (e.g., provided by the wireless network). Further, for example, based on a capability to oversample the measurements, the WTRU may also compute an oversampled frequency transformation increasing the granularity of the ΔRS metric frequency profile.

In accordance with certain embodiments of the present disclosure, systems and methods for measurement time window length mismatch detection are described as follows.

In certain representative embodiments the WTRU is configured to measure the dwelling time of the sensing task associated with the target. For example, the WTRU may be configured to measure the MD profile of the sensing target using the measured RS metric time and/or frequency profile that is reflected from the target within a measurement time window. Further, for example, the MD profile of the target may include discrete frequencies (e.g., composed of the fundamental MD frequency of the target and its harmonics) or a continuous range of frequencies based on the type of the target MD motion (e.g., periodic, non-periodic). Also, for example, the WTRU may measure the dwelling time T_{D} of the MD measurement as twice the reciprocal of the lowest frequency component in the MD profile, e.g., T_{D}=2/f_{MD}, where f_{MD} is the lowest frequency component and/or the fundamental MD frequency component in the target MD profile.

In some embodiments, the lowest frequency component and/or the fundamental MD frequency component has a low SNR, e.g., SNR less than a preconfigured threshold. For example, the WTRU may be configured to estimate the lowest frequency component or the fundamental MD frequency component as the minimum difference between any two consecutive harmonics in the measured MD profile. Further, for example, the WTRU may estimate the lowest frequency component and/or the fundamental frequency component as the highest common factor (HCF) between the frequency values of a number (e.g., all) of the measured harmonics in the target MD profile. Moreover, for example, the WTRU may be configured to use the HCF method to extract the lowest frequency component of the MD profile based on one or more of the following: a number of the measured harmonics in the target MD profile is greater than a configured threshold; a magnitude of the measured harmonics is less than a configured threshold; combinations of the same; or the like.

In some embodiments, the WTRU may measure different values for the HCF based on the selected number or group of the measured harmonics. For example, the WTRU may select one value of the HCF based on configured criteria (e.g., the lowest/maximum HCF value, HCF value associated with the highest number of harmonics, or the like).

In some embodiments, the WTRU may measure the target MD profile as a continuous range of frequencies (e.g., due to non-periodic target MD motion such as human gestures, a short measurement time window, or any other reason).

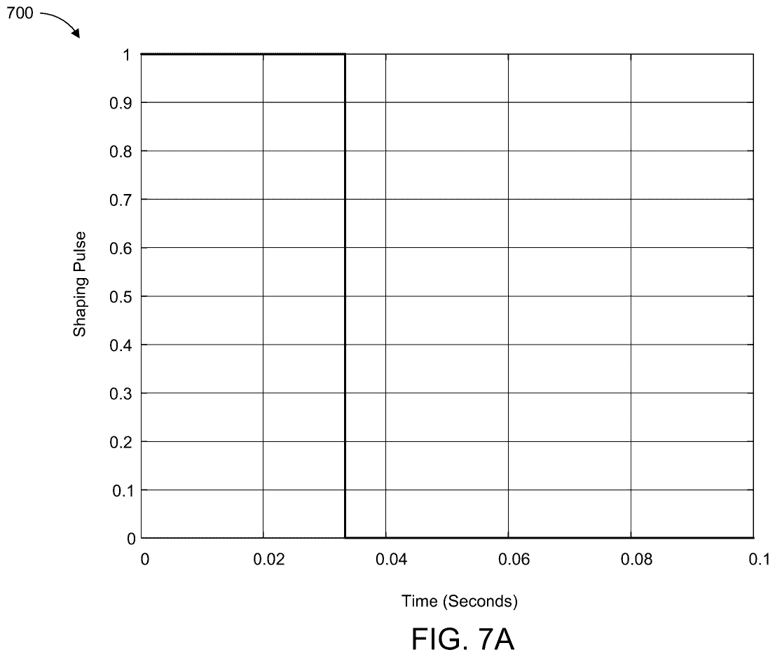

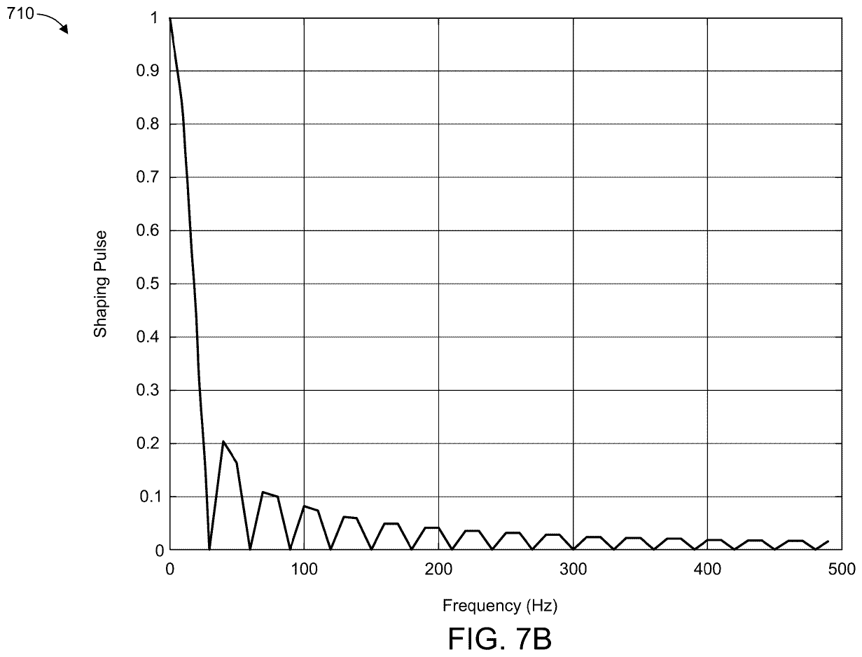

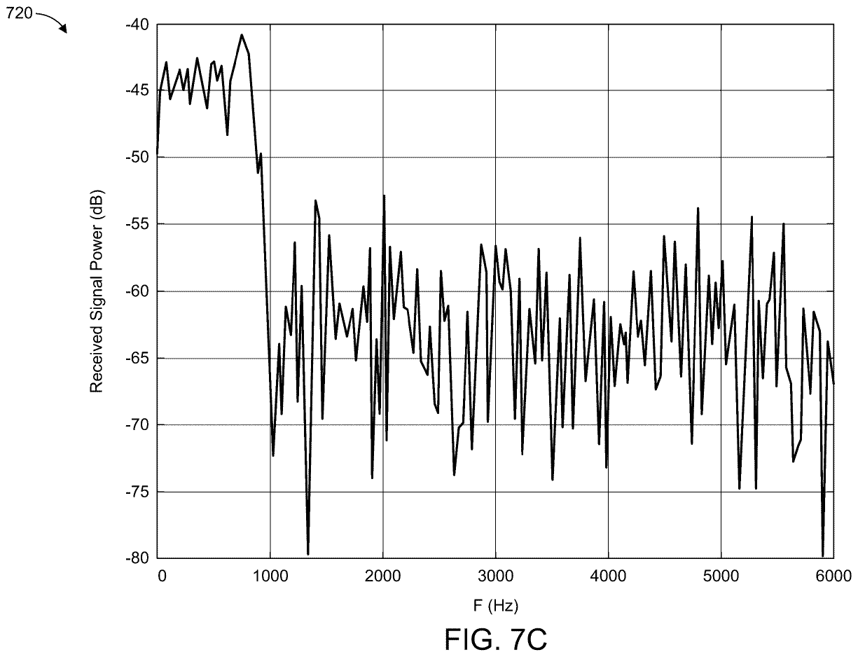

FIGS. 7A-C are illustrative charts of a target MD profile corresponding to non-periodic target MD motion, in accordance with some embodiments.

As shown in FIG. 7A, a target MD motion may be non-periodic, e.g., a shaping pulse of pulse width 1/f_{MD} in the time domain 700. As shown in FIG. 7B, the non-periodic target MD ID motion may include a range of frequencies, e.g., a shaping pulse of pulse width 1/f_{MD} in the frequency domain 710. As shown in FIG. 7C, the MD profile of the target (e.g., received signal power in the frequency domain 720) with a dwell time of 1/f_{MD} is a continuous range of frequencies due to the short measurement time window of the reflected RS from the target. In some embodiments, the WTRU may estimate the Tp using the lowest frequency component detected in the MD profile 720. For example, if the lowest frequency measured is less than a configured threshold, the WTRU may estimate the T_{D} to be a maximum configured value.

In some embodiments, the WTRU is configured to measure the dwelling time that is associated with the MD profile 720 of the target based on at least one of the following: a required accuracy for estimating the target MD frequency locations (e.g., fundamental frequency, harmonics, range of frequencies, or the like) is greater than a configured threshold; an uncertainty associated with estimating the target MD frequency locations is less than a configured threshold; a measured SNR of the MD profile 720 is greater than a configured threshold; combinations of the same; or the like.

In some embodiments, the WTRU is configured to estimate the dwelling time T_{D} according to the following equation:

$${T}_{D} = k / {f}_{MD}$$

where k is an integer value greater than or equal to 2. For example, the WTRU may select the k based on a configuration requirement (e.g., accuracy, uncertainty range, SNR, or the like).

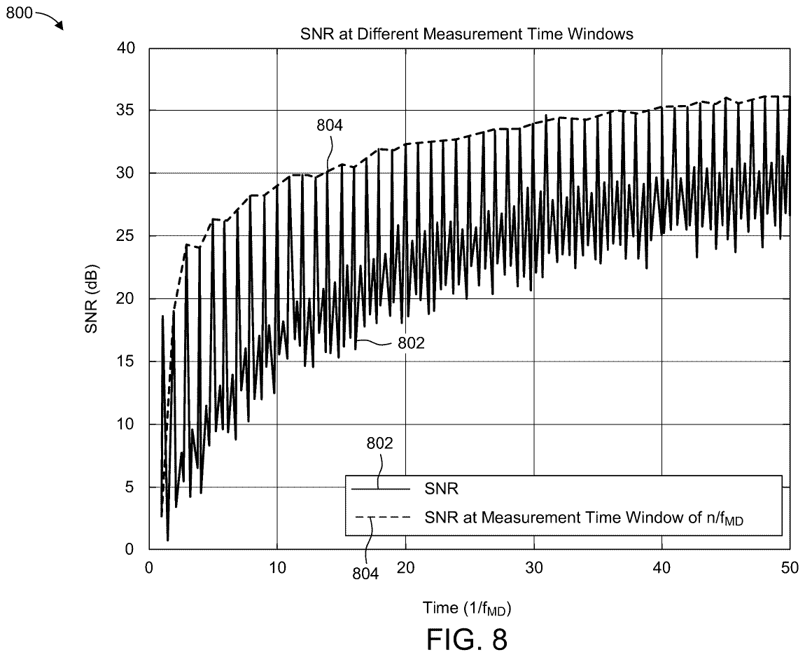

FIG. 8 is an illustrative chart 800 comparing SNR of a received RS with different measurement time window lengths, in accordance with some embodiments.

As shown in FIG. 8, SNR may generally increase as the length of the measurement time window increases. In FIG. 8, the dwelling time is expressed in multiples of 1/f_{MD}. Curve 802 includes the received MD SNR for measurement time windows of all lengths (e.g., including both integer and non-integer multiples of 1/f_{MD}. Curve 804 includes only the received MD SNR for measurement time windows of lengths that are integer multiples of 1/f_{MD}. In some embodiments, the SNR of the measurement time windows with lengths that are integer multiples of 1/f_{MD} (e.g., corresponding to curve 804) are greater than the SNR of measurement time windows with lengths that are non-integer multiples of 1/f_{MD}.

In some embodiments, the WTRU uses the RS measurements to determine the required dwelling time for each target. For example, the WTRU may use the sensing measurements, e.g., SNR, power, and RCS (e.g., ρ), and associate them to the achieved performance, e.g., range accuracy, velocity accuracy, RMSE of range estimation, or the like. Further, for example, the WTRU may use different algorithms to determine and estimate the required SNR level and the required dwelling time for each target and/or scatterer. Also, for example, the WTRU may use the existing measurements (e.g., SNR, power, RCS, angular, delay, doppler, or the like) with methods and algorithms (e.g., artificial intelligence/machine learning (AI/ML), iterative adjustment algorithms, or the like) to obtain the desired power level (e.g., desired SNR, desired accuracy, or the like), and the required dwelling time. Also, for example, the WTRU may use these measurements to obtain a preferred SNR value, e.g., SNRp for a specific target. Moreover, for example, when the achievable accuracy performance level becomes less than a particular threshold (e.g., accuracy of range estimation becomes less than a specific threshold) the WTRU may obtain the preferred SNR value in accordance with the following equation:

$${SNR}_{p} = {SNR}_{c} + Δσ$$

where SNR_{c} is the current SNR level and Δσ is the delta SNR. Even further, for example, the WTRU may obtain the required dwelling for a specific target and/or or scatterer in accordance with the following equation:

$${T}_{D} ∝ \frac{{SNR}_{p} \cdot B}{{P}_{t} \cdot ρ \cdot {G}_{r} \cdot {G}_{t}}$$

where B is the RS bandwidth, Pₜ is the transmitted power of the RS, ρ is the RCS of the target or scatterer, and Gᵣ and Gₜ are the antenna gains of the receiver (e.g., WTRU) and transmitter (e.g., TRP), respectively.

In some embodiments, the WTRU associates the set of sensing measurements, e.g., AoA, ToA, SNR, RSRP, RCS, or the like, with a specific target and/or scatterer, e.g., or set of targets and/or scatterers. For example, the WTRU may categorize the detected targets and/or scatterers based on their corresponding required dwelling time. Further, for example, the required dwelling time for each target and/or scatterer may depend on at least one of the following measurements: power measurements, e.g., SNR, RSRP; obtained target size; RCS profile; delay measurements; range; doppler measurements; velocity; size; reflectivity; combinations of the same; or the like.

In some embodiments, the WTRU uses the obtained required dwelling time and compares it to the configured measurement time window for a specific target to detect a mismatch (e.g., a length mismatch).

In certain representative embodiments, the WTRU determines detection of a measurement time window match and/or mismatch based on one or more of the following: a difference between the configured measurement time window and the measured and/or estimated dwelling time that is associated with the sensing target task is below or above a configured threshold; a difference between the measured and configured SINR of the RS metric time and/or frequency profile is below or above a configured threshold; a difference between the measured and configured number of peaks in the RS metric time profile and/or frequency profile is below or above a configured threshold; a difference between the measured and configured peak to average power ratio of the received RS metric time profile and/or frequency profile is below or above a configured threshold; an uncertainty range in the frequency of the peaks of the RS metric frequency profile is below or above a configured threshold; a measured RS metric (e.g., RSRP, SINR, RSRPP, bandwidth, or the like) is above or below a configured threshold; a specific accuracy threshold has been met, e.g., accuracy of range or velocity estimation is above or below a specific threshold; a specific uncertainty threshold is met, e.g., uncertainty of AoA, ToA, TDoA, or the like is below or above a specific threshold; SNR measurements are above or below a configured threshold; power measurements are above or below a configured threshold; a measured RCS profile is resolvable, e.g., accuracy is above or below a specific threshold; an SNR per target to time window ratio is above or below a specific threshold, a power per target to time window ratio is above or below a specific threshold; combinations of the same; or the like.

For example, the WTRU may check the SNR measurements with respect to a configured threshold and may determine at least one of the following: an average SNR received for a specific target within the configured time window is above or below the configured threshold; an average SNR received for a specific target within the configured time window is above or below the configured threshold; a peak SNR received for a specific target within the configured time window is above or below the configured threshold; a peak SNR received for a specific target within the configured time window is above or below the configured threshold; combinations of the same; or the like.

For example, the WTRU may check the power measurements with respect to a configured threshold and may determine at least one of the following: an average power received for a specific target within the configured time window is above or below the configured threshold; an average power received for a specific target within the configured time window is above or below the configured threshold; a peak power received for a specific target within the configured time window is above or below the configured threshold; a peak power received for a specific target within the configured time window is above or below the configured threshold; combinations of the same; or the like.

In some embodiments, the WTRU determines the type of the measurement time window mismatch as long or short based on at least one of the following: the configured measurement time window is longer and/or shorter than the measured dwelling time with a configured threshold; a measured SINR of the RS metric time and/or frequency profile is above or below a configured threshold; a measured MD frequency range in the RS metric frequency profile (e.g., expressed as number of harmonics, difference between the minimum and maximum detected peak locations in the frequency profile, or the like) is above or below a configured threshold; combinations of the same; or the like.

In some embodiments, the WTRU determines the degree of the measurement time window mismatch (e.g., short, extreme short, long, extreme long, or the like) based on the measured difference between the configured measurement time window time and the measured (e.g., or estimated) dwelling time. In some embodiments, the WTRU is configured to report the measurement time window time mismatch as hard (e.g., match or mismatch) or soft (e.g., in the form of levels 0-10, where level 0 indicates extreme short, level 10 indicates extreme long, and level 5 indicates match detection).

In accordance with certain representative embodiments, the WTRU is configured to bundle the measurements of received reflected RSs from the target over multiple measurement time windows based on at least one of the following conditions: the measured or estimated dwelling time that is associated with the sensing task of the target is longer than the configured measurement time window; a difference between the measured or estimated dwelling time and the configured measurement time window is greater than a configured threshold; a measured SNR of the RS metric (e.g., RSRPP, RSCP, or the like) time and/or frequency profile is less than a configured threshold; a measured number of harmonics in the RS metric frequency profile is less than a configured threshold (e.g., number of MD frequency harmonics); a measured frequency range of the RS metric profile is less than a configured threshold, (e.g., the MD frequency range); a difference between the measured and configured MD profile of the target is greater than a configured threshold; combinations of the same; or the like.

In some embodiments, the WTRU is triggered (e.g., based on a first or second configuration from the network) to bundle the RS measurement over n measurement time windows based on one or more of the aforementioned conditions.

In some embodiments, the WTRU is configured to bundle the measured received reflected RSs from the target over multiple measurement time windows. For example, the WTRU may select one or more measurement time windows to bundle and measure the reflected RSs from the target based on at least one of the following: an overall length of the bundled measurement time windows is greater than the measured or estimated dwelling time associated with the sensing task; a configuration table to associate the measured or estimated dwelling time to the number n of the bundled measurement time windows; a difference between the overall length of the n bundled measurement time windows and the measured or estimated dwelling time is less than a configured threshold; a difference between the measured or estimated and configured SNR achieved when using the bundled measurement time windows is less than a configured threshold; a difference in time between non-consecutive measurement time windows is less than the reciprocal of the configured periodicity associated with the sensing task and/or the reciprocal of the maximum measured frequency in the RS metric frequency profile (e.g., the maximum doppler and/or MD frequency); measurement time window configuration (e.g., assigned RS resources, frequency bands, lengths, or the like); a measured SNR (e.g., peak, average, or the like) of the reflected RS within the measurement time window is greater than a configured threshold; a measured accuracy (e.g., peak, average, or the like) associated with sensing measurements (e.g., RCS) of the target within the measurement time window is greater than a configured threshold, a measured uncertainty (e.g., peak, average, or the like) associated with sensing measurements (e.g., RCS) of the target within the measurement time window is less than a configured threshold, a buffer size of the WTRU to accumulate the RS measurements within a number of measurement time windows is greater than a configured threshold; AI/ML criteria to select the measurement time window to bundle, e.g., based on the aforementioned conditions; combinations of the same; or the like.

In some embodiments, different measurement time windows may have different RS configurations.

In some embodiments, the WTRU assigns an ID to the group of selected n bundled measurement time windows. In some embodiments, the WTRU assigns a separate ID for each of the selected n bundled measurement time windows.

In some embodiments, the WTRU is configured to receive the reflected RSs over n bundled measurement time windows and measure at least one of the following: an RS metric time and/or frequency profile over n measurement time windows; a difference between the RS metric time and/or frequency profile over n bundled measurement time windows and the RS metric time and/or frequency profile over the configured measurement time window; a measured MD frequency or range of frequencies, and/or MD profile of the target using the measured reflected RS metric frequency profile over n bundled measurement time windows; a difference between the MD frequency or range of frequencies and/or MD profile of the target that is measured using one and n bundled measurement time windows; a difference between the measured MD frequency or range of frequencies and/or MD profile over n bundled measurement time windows and the configured target MD range of frequencies and/or MD profile; a measured SNR of the RS metric time and/or frequency profile over n measurement time window; a difference between the SNR of the RS metric time and/or frequency profile that is measured over the configured measurement time window and n bundled measurement time windows; a difference between the measured and configured SNR of the RS metric time and/or frequency profile of the target; a dwelling time that is associated with the sensing task of the target; a difference between the measured or estimated dwelling time that is measured over n bundled measurement time windows and the configured time window; a difference between the measured dwelling time and the length of the n bundled measurement time windows; combinations of the same; or the like.

In certain representative embodiments, the WTRU may measure the received reflected RS(s) from the target over one or more segments of a measurement time window. For example, the WTRU may measure the received reflected RSs from the target over one or more segment of the measurement time window based on at least one of the following conditions: a measured or estimated dwelling time that is associated with the sensing task of the target is shorter than the configured measurement time window; a difference between the measured or estimated dwelling time and the configured measurement time window is greater than a configured threshold; a measured SNR of the RS metric (e.g., RSRPP, RSCP, or the like) time and/or frequency profile is greater than a configured threshold; a measured number of harmonics in the RS metric frequency profile is greater than a configured threshold (e.g., number of MD frequency harmonics); a measured frequency range of the RS metric profile is greater than a configured threshold, (e.g., the MD frequency range); a difference between the measured and configured MD profile of the target is less than a configured threshold; combinations of the same; or the like.

In some embodiments, the WTRU is triggered (e.g., based on a first or second configuration from the network) to segment the RS measurement within a measurement time window into m segments based on at least one of the aforementioned conditions.

In some embodiments, the WTRU is configured to measure received reflected RSs from the target during a segmented measurement time window. For example, the WTRU may select a number m of segments within the configured measurement time window based on at least one of the following: an overall length of the m segments within the configured measurement time window is greater than the measured or estimated dwelling time associated with the sensing task; a difference between the overall length of the m segments and the measured or estimated dwelling time is less than a configured threshold; a difference between the measured or estimated when using the segmented measurement time window and the configured SNR is less than a configured threshold; a difference in time between non-consecutive segments is less than the reciprocal of the configured periodicity associated with the sensing task and/or the reciprocal of the maximum measured frequency in the RS metric frequency profile (e.g., the maximum doppler and/or MD frequency).

In some embodiments, the WTRU assigns an ID to the group of selected m segments within the measurement time window. In some embodiments, the WTRU may assign a separate ID for each of the selected m segments.

In some embodiments, the WTRU may be configured to receive the reflected RSs over m segments of the configured measurement time window and measure at least one of the following: an RS metric time and/or frequency profile over m segments of the measurement time window; a difference between the RS metric time and/or frequency profile over m segments of the measurement time window and the RS metric time and/or frequency profile over the configured measurement time window; a measured MD frequency or range of frequencies and/or MD profile of the target using the measured reflected RS metric frequency profile over m segments of the measurement time window; a difference between the MD frequency or range of frequencies and/or MD profile of the target that is measured within the configured measurement time window and m segments of the measurement time window; a difference between the measured MD frequency or range of frequencies and/or MD profile over m segments of the measurement time window and the configured target MD range of frequencies and/or MD profile; a measured SNR of the RS metric time and/or frequency profile over m segments of the measurement time window; a difference between the SNR of the RS metric time and/or frequency profile that is measured over the configured measurement time window and m segments of the measurement time window; a difference between the measured and configured SNR of the RS metric time and/or frequency profile of the target; a dwelling time that is associated with the sensing task of the target; a difference between measured and/or estimated dwelling time that is measured over m segments of the measurement time window and the configured time window; a difference between the measured dwelling time and the length of the m segments of the measurement time window; AI/ML criteria to select the measurement time window segments based on a combination of the previous conditions; combinations of the same; or the like.

In some embodiments, the WTRU is configured to measure the received RSs For example, the WTRU may be configured to report the measurements of the reflected RSs from the target within a duration of “n*MTW+m*STW”, where n is the number of measurement time window, MTW is the measurement time window length (e.g., in time slots, resource blocks, or the like), m is the number of segment time window, and the STW is the segment time window length.

In certain representative embodiments, the WTRU receives the reflected RSs from the target over a number of measurement instances. For example, the WTRU may determine to change bundling and/or segmentation of measurement time windows based on at least one of the following: a measured change in the difference between the configured measurement time window and the measured or estimated dwelling time that is associated with the sensing target task is greater than a configured threshold; a measured change in the difference between the measured and configured SINR of the RS metric time and/or frequency profile is above configured threshold; a measured change in the difference between the measured and configured number of peaks in the RS metric time profile and/or frequency profile is greater than a configured threshold; a measured change in the difference between the measured and configured peak to average power ratio of the received RS metric time profile and/or frequency profile is above a configured threshold; a measured change in the uncertainty range in the frequency of the peaks of the RS metric frequency profile is greater than a configured threshold; a measured change in the measured RS metric (e.g., RSRP, SINR, RSRPP, bandwidth, or the like) is above a preconfigured threshold.

Based on any of the aforementioned conditions, the WTRU may change one or more of the following: selection of the n bundled measurement time windows (e.g., change the number n, change the selected measurement time window, change the ID assigned to the selected time window); selection of the m segments within the measurement time window (e.g., change the number m, change the selected segment within the time window, change the length of the segment, change the ID assigned to the segment, or the like); selection of the n*m bundled and/or segmented measurement time windows; combinations of the same or the life.

In certain representative embodiments, the WTRU determines to deactivate the bundling and/or the segmentation of the measurement time window based on at least one of the following: detection of matching measurement time windows, a measured or estimated dwelling time is above a configured threshold (e.g., due to buffer limit size, latency requirement, or the like); measured target mobility (e.g., doppler, velocity, or the like) is less than a configured threshold; a lowest measured or estimated frequency component of the target MD profile is less than a configured threshold; a measured change in the RS metric time profile of the target with respect to an average value is less than a configured threshold; combinations of the same; or the like.

In accordance with certain embodiments of the present disclosure, WTRU behavior for reporting is described as follows.

In certain representative embodiments, the WTRU performs target sensing task measurements and sends a target sensing task measurement report (e.g., periodic, aperiodic, or semi-persistent report) over an uplink control or data channel.

In certain representative embodiments, the WTRU determines a measurement time window match or mismatch and sends a measurement report (e.g., periodic, aperiodic, or semi-persistent report) including at least one of the following: a determined measurement time window match or mismatch detection; RS measurements; a recommended measurement time window length; combinations of the same; or the like.

For example, the determined measurement time window match or mismatch detection may include at least one of the following: an associated target ID and/or sensing task ID; a dwelling time measurement (e.g., criteria of measurement or estimation, assigned RS resources, AI/ML model, associated accuracy, uncertainty range, or the like); a difference between the measured or estimated dwelling time and the configured measurement time window; a type of the determined window match or mismatch detection (e.g., long, short, or the like); a degree of the determined window match or mismatch detection (e.g., extreme long, extreme short, or any other criteria for degree evaluation); combinations of the same; or the like.

For example, RS measurements included in the measurement report may include at least one of the following: assigned RS resources for dwelling time measurement; RS measurements (e.g., power, phase, RSRP, RSRPP, RSCP, SNR, average SNR, or the like); RS metric profile measurements (e.g., time profile, frequency profile); RS measurements associated accuracy and/or uncertainty range; target sensing measurements associated with the corresponding accuracy and uncertainty range (e.g., RCS, RCS profile, target location, or the like); target MD profile; combinations of the same; or the like. Further, for example, the target MD profile may include at least one of the following: measured MD profile frequency locations (e.g., as discrete values or continuous range of frequencies); measured MD profile magnitude and/or phase; estimated lowest frequency components or fundamental frequency components of the target MD profile; associated accuracy and uncertainty range (e.g., in the frequency locations, range, MD profile magnitude, or the like); combinations of the same; or the like.

For example, recommended measurement time window lengths may include at least one of the following: associated targets and/or sensing tasks; a recommended length (e.g., based on the measured dwelling time, RS measurement accuracy, uncertainty range, or the like); a bundled n measurement time windows and/or a measurement time window segmented into m segments; selected measurement time windows for bundling and/or segmentation associated with the selection criteria (e.g., based on the assigned RS resources to each measurement time window, accuracy achieved at a specific measurement time window, or the like).

In certain representative embodiments, the WTRU is configured (e.g., based on a first configuration or subsequent configurations) to measure the RS reflected from the target during bundled and/or segmented measurement time windows. For example, the WTRU may send a report to the network (e.g., periodic, aperiodic, or semi-persistent report) on the reflected RS measurements from the target during the bundled and/or segmented measurement time windows including one or more of the following: bundling and/or segmenting information of measurement time windows; RS measurements performed during the bundled and/or segmented measurement time windows; combinations of the same; or the like.

For example, bundling and/or segmenting information of measurement time windows may include at least one of the following: associated targets and/or sensing tasks; a total length of the bundled and/or the segmented measurement time windows (e.g., in slots, OFDM symbols, or the like); a difference between the total length of the bundled and/or the segmented measurement time windows and the measured dwelling time; a number n of the bundled measurement time windows and/or the number m of the segments within a measurement time window; selection criteria of the bundled and/or segmented measurement time windows (e.g., based on the assigned RS resources to each measurement time window, accuracy achieved at a specific measurement time window, or the like).

For example, RS measurements performed during the bundled and/or segmented measurement time windows may include at least one of the following: RS measurements (e.g., power, phase, RSRP, RSRPP, RSCP, SNR, average SNR, or the like); a comparison (e.g., difference, correlation, or the like) between the RS measurements over the bundled and/or segmented measurement time windows and the RS measurements over a reference measurement time window length (e.g., measurement time window length in the current configuration or previous configuration, or any other configured reference); RS metric profile measurements (e.g., time profile, frequency profile, measured number of peaks, peak to average power ratio, average SNR, or the like); a comparison (e.g., difference, correlation, or the like) between the RS metric profile measurements over the bundled and/or segmented measurement time windows and the RS metric profile measurements over a reference measurement time window length (e.g., measurement time window length in the current configuration or previous configuration, or any other configured reference); an RS measurement-associated accuracy and/or uncertainty range; a comparison (e.g., a difference, correlation, or the like) between the RS measurement-associated accuracy and/or uncertainty range over the bundled and/or segmented measurement time windows and the RS measurement-associated accuracy and/or uncertainty range over a reference measurement time window length (e.g., measurement time window length in the current configuration or previous configuration, or any other configured reference); target sensing measurements associated with the corresponding accuracy and uncertainty range (e.g., RCS, RCS profile, target location, or the like); a comparison (e.g., difference, correlation, or the like) between the target sensing measurements over the bundled and/or segmented measurement time windows and the target sensing measurements over a reference measurement time window length (e.g., measurement time window length in the current configuration or previous configuration, or any other configured reference); a target MD profile; a comparison (e.g., difference, correlation, or the like) between the target MD profile measurements over the bundled and/or segmented measurement time windows and the target MD profile measurements over a reference measurement time window length (e.g., measurement time window length in the current configuration or previous configuration, or any other configured reference); combinations of the same; or the like.

For example, the target MD profile may include at least one of the following: measured MD profile frequency locations (e.g., as discrete values or continuous range of frequencies); measured MD profile magnitude and/or phase; estimated lowest frequency components or fundamental frequency components of the target MD profile; associated accuracy and uncertainty range (e.g., in the frequency locations, range, MD profile magnitude, or the like); combinations of the same; or the like.

In accordance with certain embodiments of the present disclosure, additional WTRU behaviors are described as follows.

In some embodiments, the WTRU performs measurements on the RS reflected from the target over multiple measurement occasions (e.g., multi-slot level, with repetition factor and/or time gap configurations). For example, the WTRU may determine that the report is invalid or outdated based on at least one of the following: a change in the determined measurement time window match or mismatch detection; a change in bundling and/or segmentation of the measurement time windows; a change in the RS measurements that are performed over the one or more bundled and/or segmented measurement time windows; combinations of the same; or the like.

For example, the change in the determined measurement time window match or mismatch detection may include at least one of the following: a change in status from match to mismatch, a change in status from mismatch to match; a change in the mismatch detection type (e.g., long, short); a change in the mismatch degree (e.g., extreme long, extreme short); combinations of the same; or the like.

For example, the change in the bundling and/or segmentation of the measurement time windows may include at least one of the following: a change in the total length of the bundled and/or segmented measurement time windows (e.g., in slots, OFDM symbols, or the like) is greater than a configured threshold; a change in the difference between the total length of the bundled and/or segmented measurement time windows and the measured dwelling time is greater than a configured threshold; a change in the number n of the bundled measurement time windows and/or the number m of the segments within a measurement time window is greater than a configured threshold; a change in the selection criteria of the bundled and/or segmented measurement time windows (e.g., based on the assigned RS resources to each measurement time window, accuracy achieved at a specific measurement time window, or the like); combinations of the same; or the like.

For example, the change in the RS measurements that are measured over one or more bundled and/or segmented measurement time windows may include at least one of the following: a change in RS measurements (e.g., power, phase, RSRP, RSRPP, RSCP, SNR, average SNR, or the like) is greater than a configured threshold, a change in RS metric profile measurements (e.g., time profile, frequency profile, measured number of peaks, peak to average power ratio, average SNR, or the like) is greater than a configured threshold; a change in a RS measurement-associated accuracy and/or uncertainty range is greater than a configured threshold; a change in target sensing measurements associated with the corresponding accuracy and uncertainty range (e.g., RCS, RCS profile, target location, or the like) is greater than a configured threshold; a change in the measured target MD profile is greater than a configured threshold; combinations of the same; or the like.

In some embodiments, based on identifying any of the aforementioned changes, the WTRU may perform new time window measurements. For example, the WTRU determines to send an updated report in aperiodic, periodic, or semi-persistent form over a UL control or data channel, including at least one of the following: updated measurement time window match or mismatch detection; updated RS measurements; updated bundling and/or segmentation information of the measurement time window; a time stamp of the updated measurements, e.g., in absolute or relative time, number of slots, or frames (e.g., relative to a known reference); combinations of the same or the like.

For example, updated measurement time window match or mismatch detection that may include one or more of the following: updated measurement time window match or mismatch status (e.g., match, mismatch); updated measurement time window match or mismatch type, updated measurement time window match or mismatch degree; combinations of the same; or the like.

For example, updated RS measurements may include at least one of the following: updated RS measurements (e.g., power, phase, RSRP, RSRPP, RSCP, SNR, average SNR, or the like); updated RS metric profile measurements (e.g., time profile, frequency profile, measured number of peaks, peak to average power ratio, average SNR, or the like); updated RS measurement-associated accuracy and/or uncertainty range; updated target sensing measurements associated with the corresponding accuracy and uncertainty range (e.g., RCS, RCS profile, target location, or the like); updated target MD profile; combinations of the same; or the like.

For example, updated bundling and/or segmentation information of the measurement time windows may include at least one of the following: an updated total length of the bundled and/or segmented measurement time windows (e.g., in slots, OFDM symbols, or the like); an updated difference between the total length of the bundled and/or segmented measurement time windows and the measured dwelling time; an updated number n of the bundled measurement time windows and/or the number m of the segments within a measurement time window; updated selection criteria of the bundled and/or segmented measurement time windows; combinations of the same; or the like.

In some embodiments, the WTRU is configured to perform the measurements over multiple measurement occasions (e.g., multi-slot level, with repetition factor, time gap configurations). For example, the WTRU may determine that reporting can be terminated based on at least one of the following: a determination of no change in the measurement time window match or mismatch detection (e.g., type, degree, or the like) for a configured threshold time or configured number of measurement occasions; a determination of no change in the difference between the configured measurement time window and the measured or estimated dwelling time that is associated with the sensing target is greater than or less than a configured threshold for a configured threshold time or configured number of measurement occasions; a determination of no change in the bundling and/or segmentation of the measurement time windows (e.g., number or selected measurement time windows or segments) for a configured threshold time or configured number of measurement occasions; a determination of no change of the measured SINR of the RS metric time and/or frequency profile is less than or greater than a configured threshold for a configured threshold time or configured number of measurement occasions; a determination of no change of number of peaks in the RS metric time and/or frequency profile for a configured threshold time or configured number of measurement occasions; a determination of no change of measured peak to average power ratio of the received RS metric time and/or frequency profile is less than or greater than a configured threshold for a configured threshold time or configured number of measurement occasions; a determination of no change of uncertainty range in the frequency of the peaks of the RS metric frequency profile is greater than or less than a configured threshold for a configured threshold time or configured number of measurement occasions; a determination of no change of measured RS metric (e.g., RSRP, SINR, RSRPP, bandwidth, or the like) is less than or greater than a preconfigured threshold for a configured threshold time or configured number of measurement occasions; a determination of no change in one or more of the metrics or key performance indicators (KPIs) over a predefined period; achieving the sensing requirements over a defined period; a time elapsed since the last reporting of precoding feedback information exceeding a maximum absolute or relative duration; a low-battery indication by the WTRU; a low buffer size indication by the WTRU for accumulating the RS measurements; a termination indication by the wireless network; combinations of the same; or the like.

In some embodiments, based on any of the aforementioned conditions, the WTRU terminates the sensing task and sends a report over an UL control or data channel indicating the recommendation to terminate the measurement procedure and at least one of the following: a termination indicator, e.g., referring to the reason of termination; termination time stamp; detailed termination reason (e.g., network indicator, low buffer size, or the like); a latest sensing report; combinations of the same; or the like.

For example, the latest sensing report may include at least one of: requested information, measurements performed, estimated dwelling time window, measurement time window, existing triggering conditions, WTRU actions performed, time stamps, RS signal ID used for sensing, combinations of the same, or the like.

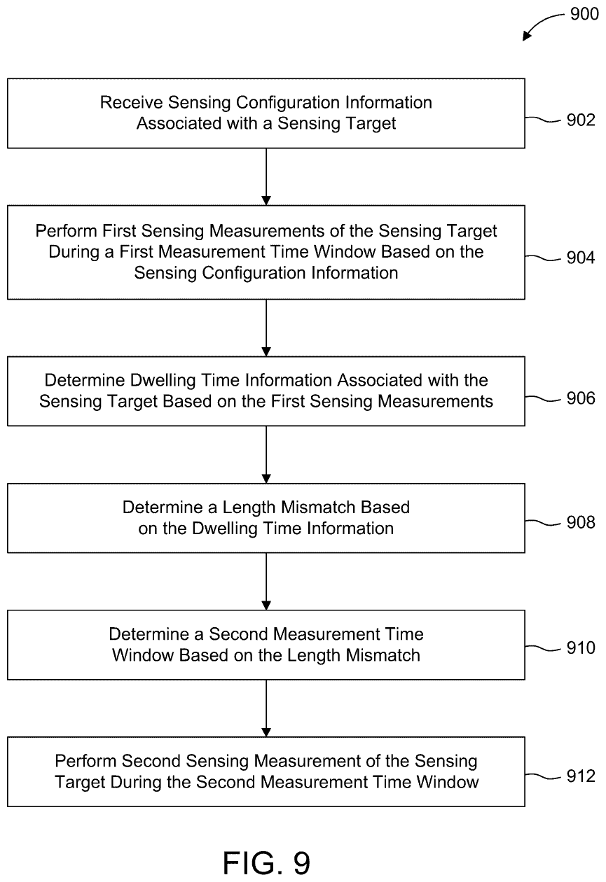

In certain representative embodiments, as shown in FIG. 9, a process 900 is performed by a WTRU (e.g., WTRU 102 of FIGS. 1A-D) in connection with a wireless network (e.g., RAN 104 and 113 of FIGS. 1A-D), which may be implemented in communications system 100 illustrated in FIG. 1A-1D.

At step 902, the WTRU receives sensing configuration information associated with a sensing target. For example, the sensing target may include a human, animal, vehicle, rock, or UAV (e.g., UAV 204 of FIG. 2). In some embodiments, the sensing configuration information includes at least one of: RS configurations, sensing RS measurement and reporting configurations, sensing assistance information, combinations of the same, or the like. In some embodiments, the sensing configuration information may indicate the first measurement time window in terms of at least one of: a duration (e.g., in quantity of seconds, symbols, slots, frames, or subframes); a start time (e.g., in absolute time, system time, relative time, SNF index, slot index, symbol index, frame index, or subframe index); an end time (e.g., in absolute time, system time, relative time, SNF index, slot index, symbol index, frame index, or subframe index); combinations of the same; or the like.

At step 904, the WTRU performs first sensing measurements of the sensing target during a first measurement time window based on the sensing configuration information. For example, the first sensing measurements may include at least one of the following: angle measurements, temporal measurements, power measurements, mobility measurements, uncertainty in doppler measurements, RCS profile, combinations of the same, or the like. In some embodiments, the WTRU determines a RS metric (e.g., RSRP, RSRPP, RSCP, SINR, or the like) profile based on the first sensing measurements. In some embodiments, the WTRU measures the difference between two profiles, e.g., between a determined RS-metric profile and a configured profile.

At step 906, the WTRU determines dwelling time information associated with the sensing target based on the sensing measurements. In some embodiments, the dwelling time information includes a measured or estimated dwelling time. In some embodiments, the WTRU may determine a measured dwelling time based on an MD profile of the sensing target. For example, the WTRU may determine the measured dwelling time to be the lowest frequency component of the MD profile, e.g., via the HCF method. Further, for example, the MD profile of the sensing target may be determined based on the RS-metric profile.

At step 908, the WTRU determines a length mismatch based on the dwelling time information. In some embodiments, determining the length mismatch comprises comparing the dwelling time information to a threshold. In some embodiments, comparing the dwelling time information to a threshold includes determining a difference between the first measurement time window (e.g., length) and a measured or estimated dwelling time (e.g., of the dwelling time information) to be greater than the threshold. In some embodiments, the WTRU determines a length mismatch based on at least one of the following: a measured SINR of an RS metric time profile or an RS metric frequency profile is less than a noise threshold; a measured number of peaks of the RS metric time profile or the RS metric frequency profile is less than a peak threshold; a measured peak to average power ratio of the RS metric time profile or the RS metric frequency profile is less than a power threshold; an uncertainty range in a frequency of peaks of the RS metric frequency profile is greater than an uncertainty threshold; an RS metric is below a metric threshold; combinations of the same; or the like. For example, the comparison may indicate that the length mismatch is long (e.g., first measurement time window is longer than the estimated dwelling time) or short (e.g., first measurement time window is shorter than the estimated dwelling time). Further, for example, the WTRU may determine a degree of the measurement time window mismatch (e.g., extreme short, short, long, extreme long) based on the difference between the estimated or measured dwelling time and the first measurement time window length.

At step 910, the WTRU determines a second measurement time window based on the length mismatch. In some embodiments, the WTRU determines a short length mismatch and determines a second measurement time window by bundling a plurality of measurement time windows. In such embodiments, the WTRU may select the plurality of measurement time windows for bundling based on at least one of: a difference between a total length of the plurality of measurement time windows and a dwelling time of the dwelling time information is less than a selection threshold; a measured signal-to-interference-plus-noise-ratio (SINR) of a reference signal (RS) metric time profile or an RS metric frequency profile associated with the plurality of measurement time windows is greater than a noise threshold; a measured number of peaks of the RS metric time profile or the RS metric frequency profile associated with the plurality of measurement time windows is greater than a peak threshold; a measured peak to average power ratio of the RS metric time profile or the RS metric frequency profile associated with the plurality of measurement time windows is greater than a power threshold; an uncertainty range in the RS metric frequency profile associated with the plurality of measurement time windows is less than an uncertainty threshold; combinations of the same; or the like. In some embodiments, selecting the plurality of measurement time windows is based on a configuration table associating a dwelling time of the dwelling time information to the plurality of measurement time windows. In some embodiments, the WTRU determines a long length mismatch and determines a second sensing measurement window by selecting one or more segments of a subsequent measurement time window. In some embodiments, selecting the one or more segments is based on at least one of: a total length of the one or more segments is longer than a dwelling time of the dwelling time information; a difference between the total length of the one or more segments and the dwelling time is less than a selection threshold; a difference between a SNR associated with the one or more segments and a SNR associated with the first measurement time window is less than a noise threshold; a difference in time between the one or more segments is less than a reciprocal of a periodicity or a maximum frequency in the sensing configuration information; combinations of the same; or the like.

At step 912, the WTRU performs second sensing measurements of the sensing target during the second measurement time window. In some embodiments, the performing the second sensing measurements includes bundling sensing measurements from a plurality of measurement time windows. In some embodiments, the performing the second sensing measurements includes selecting one or more segments of a subsequent measurement time window and performing the second sensing measurements during the one or more segments. In some embodiments, the WTRU reports, to a wireless network entity, an indication of the length mismatch, an indication of the second measurement time window, and the second sensing measurements. For example, the report may additionally include comparisons between the RS metrics, RS metric profiles, RS measurement-associated accuracy/uncertainty, and/or target MD profiles of the first measurement time window and the second measurement time window.

In some embodiments, a WTRU (e.g., 102 of FIGS. 1A-D) is configured to perform any combination of the above-referenced steps of the method 900.

Certain embodiments of the present disclosure describe a sensing mode in which a WTRU is a receiver and a wireless network (e.g., TRP, gNB) is a transmitter. However, this does not preclude the applicability of the systems and methods described herein to all other sensing modes.

In the present disclosure, “RS metric”, “metric”, “RS measurement”, “sensing measurement”, and “measurement” may be used interchangeably.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method performed by a wireless transmit/receive unit (WTRU), the method comprising:
receiving sensing configuration information associated with a sensing target;
performing, based on the sensing configuration information, first sensing measurements of the sensing target during a first measurement time window;
determining, based on the first sensing measurements, dwelling time information associated with the sensing target;
determining a length mismatch based on the dwelling time information;
determining a second measurement time window based on the length mismatch; and
performing second sensing measurements of the sensing target during the second measurement time window.

2. The method of claim 1, wherein:
determining the length mismatch comprises comparing the dwelling time information to a threshold;
the comparing indicates that the length mismatch is short; and
performing the second sensing measurements comprises bundling sensing measurements from a plurality of measurement time windows.

3. The method of claim 2, wherein selecting the plurality of measurement time windows is based on at least one of:
a difference between a total length of the plurality of measurement time windows and a dwelling time of the dwelling time information is less than a selection threshold;
a measured signal-to-interference-plus-noise-ratio (SINR) of a reference signal (RS) metric time profile or an RS metric frequency profile associated with the plurality of measurement time windows is greater than a noise threshold;
a measured number of peaks of the RS metric time profile or the RS metric frequency profile associated with the plurality of measurement time windows is greater than a peak threshold;
a measured peak to average power ratio of the RS metric time profile or the RS metric frequency profile associated with the plurality of measurement time windows is greater than a power threshold; or
an uncertainty range in the RS metric frequency profile associated with the plurality of measurement time windows is less than an uncertainty threshold.

4. The method of claim 2, wherein selecting the plurality of measurement time windows is based on a configuration table associating a dwelling time of the dwelling time information to the plurality of measurement time windows.

5. The method of claim 1, wherein:
determining the length mismatch comprises comparing the dwelling time information to a threshold;
the comparing indicates that the length mismatch is long; and
performing the second sensing measurements comprises:
selecting one or more segments of a subsequent measurement time window; and
performing the second sensing measurements during the one or more segments.

6. The method of claim 5, wherein selecting the one or more segments is based on at least one of:
a total length of the one or more segments is longer than a dwelling time of the dwelling time information;
a difference between the total length of the one or more segments and the dwelling time is less than a selection threshold;
a difference between a signal-to-noise-ratio (SNR) associated with the one or more segments and a SNR associated with the first measurement time window is less than a noise threshold; or
a difference in time between the one or more segments is less than a reciprocal of a periodicity or a maximum frequency in the sensing configuration information.

7. The method of claim 5, wherein:
the dwelling time information comprises an estimated dwelling time;
comparing the dwelling time information to the threshold comprises determining a difference between the first measurement time window and the estimated dwelling time to be greater than the threshold; and
the first measurement time window is longer than the estimated dwelling time.

8. The method of claim 1, further comprising:
reporting, to a wireless network entity, an indication of the length mismatch, an indication of the second measurement time window, and the second sensing measurements.

9. The method of claim 1, wherein the first measurement time window is defined by at least one of:
a duration expressed in a quantity of seconds, symbols, slots, frames, or subframes;
a start time expressed in absolute time, system time, relative time, serving node function (SNF) index, slot index, symbol index, frame index, or subframe index; or
an end time expressed in absolute time, system time, relative time, SNF index, slot index, symbol index, frame index, or subframe index.

10. The method of claim 1, wherein determining the length mismatch is based on at least one of:
a measured SINR of an RS metric time profile or an RS metric frequency profile is less than a noise threshold;
a measured number of peaks of the RS metric time profile or the RS metric frequency profile is less than a peak threshold;
a measured peak to average power ratio of the RS metric time profile or the RS metric frequency profile is less than a power threshold;
an uncertainty range in a frequency of peaks of the RS metric frequency profile is greater than an uncertainty threshold; or
an RS metric is below a metric threshold.

11. A wireless transmit/receive unit (WTRU) comprising:
a processor; and
a transceiver, wherein the WTRU is configured to:
receive sensing configuration information associated with a sensing target;
perform, based on the sensing configuration information, first sensing measurements of the sensing target during a first measurement time window;
determine, based on the first sensing measurements, dwelling time information associated with the sensing target;
determine a length mismatch based on the dwelling time information;
determine a second measurement time window based on the length mismatch; and
perform second sensing measurements of the sensing target during the second measurement time window.

12. The WTRU of claim 11, wherein:
the WTRU is configured to determine the length mismatch by comparing the dwelling time information to a threshold;
the comparing indicates that the length mismatch is short; and
the WTRU is configured to perform the second sensing measurements by bundling sensing measurements from a plurality of measurement time windows.

13. The WTRU of claim 12, wherein the WTRU is configured to select the plurality of measurement time windows based on at least one of:
a difference between a total length of the plurality of measurement time windows and a dwelling time of the dwelling time information is less than a selection threshold;
a measured signal-to-interference-plus-noise-ratio (SINR) of a reference signal (RS) metric time profile or an RS metric frequency profile associated with the plurality of measurement time windows is greater than a noise threshold;
a measured number of peaks of the RS metric time profile or the RS metric frequency profile associated with the plurality of measurement time windows is greater than a peak threshold;
a measured peak to average power ratio of the RS metric time profile or the RS metric frequency profile associated with the plurality of measurement time windows is greater than a power threshold; or
an uncertainty range in the RS metric frequency profile associated with the plurality of measurement time windows is less than an uncertainty threshold.

14. The WTRU of claim 12, wherein the WTRU is configured to select the plurality of measurement time windows based on a configuration table associating a dwelling time of the dwelling time information to the plurality of measurement time windows.

15. The WTRU of claim 11, wherein:
the WTRU is configured to determine the length mismatch by comparing the dwelling time information to a threshold;
the comparing indicates that the length mismatch is long; and
the WTRU is configured to perform the second sensing measurements by:
selecting one or more segments of a subsequent measurement time window; and
performing the second sensing measurements during the one or more segments.

16. The WTRU of claim 15, wherein the WTRU is configured to select the one or more segments based on at least one of:
a total length of the one or more segments is longer than a dwelling time of the dwelling time information;
a difference between the total length of the one or more segments and the dwelling time is less than a selection threshold;
a difference between a signal-to-noise-ratio (SNR) associated with the one or more segments and a SNR associated with the first measurement time window is less than a noise threshold; or
a difference in time between the one or more segments is less than a reciprocal of a periodicity or a maximum frequency in the sensing configuration information.

17. The WTRU of claim 15, wherein:
the dwelling time information comprises an estimated dwelling time;
the WTRU is configured to compare the dwelling time information to the threshold by determining a difference between the first measurement time window and the estimated dwelling time to be greater than the threshold; and
the first measurement time window is longer than the estimated dwelling time.

18. The WTRU of claim 11, wherein the WTRU is further configured to:
report, to a wireless network entity, an indication of the length mismatch, an indication of the second measurement time window, and the second sensing measurements.

19. The WTRU of claim 11, wherein the first measurement time window is defined by at least one of:
a duration expressed in a quantity of seconds, symbols, slots, frames, or subframes;
a start time expressed in absolute time, system time, relative time, serving node function (SNF) index, slot index, symbol index, frame index, or subframe index; or
an end time expressed in absolute time, system time, relative time, SNF index, slot index, symbol index, frame index, or subframe index.

20. The WTRU of claim 11, wherein the WTRU determines the length mismatch based on at least one of:
a measured SINR of an RS metric time profile or an RS metric frequency profile is less than a noise threshold;
a measured number of peaks of the RS metric time profile or the RS metric frequency profile is less than a peak threshold;
a measured peak to average power ratio of the RS metric time profile or the RS metric frequency profile is less than a power threshold;
an uncertainty range in a frequency of peaks of the RS metric frequency profile is greater than an uncertainty threshold; or
an RS metric is below a metric threshold.
